(19) United States
(12) Patent Application Publication
(10) Pub. No.: US 2006/0007084 A1
(43) Pub. Date: Jan. 12, 2006

(54) Liquid crystal display device and method of driving liquid crystal display device

(75) Inventors: Masahiko Takeoka, Nara (JP); Seiji Kawaguchi, Osaka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd, Tokyo (JP)

(21) Appl. No.: 11/094,460

(22) Filed: Mar. 31, 2005

(30) Foreign Application Priority Data
Apr. 1, 2004 (JP) 2004-109273

(51) Int. Cl. G09G 3/36

(52) U.S. Cl. 345/87

(57) ABSTRACT

The liquid crystal display device includes a liquid crystal display panel provided with source signal lines and gate signal lines arranged in matrix form and liquid crystal display elements using OCB mode liquid crystal provided at intersections between the source signal lines and gate signal lines, a gate driver which supplies a gate signal to the gate signal lines and a source driver which supplies a voltage corresponding to gradation of the display data to the source signal lines during a display period and supplies a voltage to prevent counter-transfer to the source signal lines during a counter-transfer prevention drive period, and the source driver supplies a voltage lower by a predetermined value than the voltage corresponding to the black color as the voltage to prevent counter-transfer.

### BACKGROUND OF THE INVENTION

1. Field of the Invention

The present invention relates to a liquid crystal display device using an OCB mode liquid crystal and a method of driving the liquid crystal display device.

2. Prior Art of the Invention

A liquid crystal display device is thin and light, and has been used in an increasingly wide range of application as a substitute for a conventional cathode ray tube in recent years. However, a TN (Twisted Nematic) aligned liquid crystal panel which is currently used in a wide range has a narrow view angle, a slow response speed and its image quality is inferior to that of a cathode ray tube, for example, when a moving image is displayed its image appears to linger.

In contrast, a liquid crystal display device using an OCB (Optically Compensated Birefringence) mode featuring high-speed response and a high view angle is available in recent years. This liquid crystal display device is designed to obtain a wide view angle through visual compensation by bend-aligning the liquid crystal and further combining this with an optical phase compensation film.

FIG. 13 shows a schematic cross-sectional view of a liquid crystal display panel making up a liquid crystal display device using an OCB mode. FIGS. 13(a), (b) are schematic cross-sectional views of the liquid crystal display panel making up the liquid crystal display device using the OCB mode when a voltage is applied and FIG. 13(c) is a schematic cross-sectional view of the liquid crystal display panel making up the liquid crystal display device using the OCB mode when no voltage is applied.

Nematic liquid crystal, as shown as liquid crystal molecule 52 in FIG. 13(a) or the like, is injected between glass substrates 51 of the liquid crystal display panel making up the liquid crystal display device using an OCB mode. An alignment state of the liquid crystal when no voltage is applied is called a “spray state 53.” When power to the liquid crystal display device is turned ON, it is necessary to perform a drive called a “transfer drive.” That is, a transfer drive refers to a drive that applies a relatively large voltage of approximately 20 to 25 V to this liquid crystal layer at power-up of the liquid crystal display device and thereby transfers the liquid crystal layer from the spray state 53 shown in FIG. 13(c) to bent states 54a, 54b shown in FIGS. 13(a), (b). It is a feature of the OCB mode that a display is performed using this bent states 54a, 54b and transmittance of the panel is changed by changing the magnitude of the voltage.

The bent state 54a shown in FIG. 13(a) shows a bent state during a white display and the bent state 54b in FIG. 13(b) shows a bent state during a black display.

Continuously applying a voltage of 2 V or less to the liquid crystal display panel of the liquid crystal display device using the OCB mode causes the liquid crystal display panel to gradually transition from the bent state 54a, 54b to the spray state 53 (hereinafter this transition will be referred to as “counter-transfer”). To prevent such counter-transfer, the liquid crystal display device using the OCB mode performs a drive called a “counter-transfer prevention drive.”

That is, the counter-transfer prevention drive refers to a drive for preventing counter-transfer by periodically applying a voltage corresponding to a black color to each pixel. The counter-transfer prevention drive includes a counter-transfer prevention drive called a “double-speed conversion” which alternately performs an operation of applying a voltage corresponding to a black color to each pixel to prevent counter-transfer and an operation of applying a display voltage. Such a drive allows a high contrast display to be realized. However, the double-speed conversion needs to drive each pixel twice as fast as when no counter-transfer prevention drive is performed, and therefore it is difficult to drive the liquid crystal display device. It is a 1.25-fold speed conversion shown below that solves such a problem.

A 1.25-fold speed conversion which is a kind of counter-transfer prevention drive will be explained using FIG. 14 and FIG. 15.

FIG. 14 illustrates the vicinity of 1 pixel, a source driver 11 and a black insertion voltage generation circuit 101 of a liquid crystal display panel making up a liquid crystal display device using an OCB mode.

A source signal line 13 is connected to the source driver 11 through a switch 25 and a gate signal line 15 is connected to a gate driver (not shown). Furthermore, a precharge line 24 is connected to each source signal line 13 through each switch 25. The precharge line 24 is connected to the black insertion voltage generation circuit 101. That is, the switch 25 can select whether the source signal line 13 is connected to the source driver 11 or connected to the black insertion voltage generation circuit 101 through the precharge line 24.

A pixel transistor 18, a pixel electrode 19 and a storage capacitor Cst 20 for adding a compensation potential are formed at the intersection between the source signal line 13 and gate signal line 15 and a liquid crystal layer (not shown) in an OCB mode is sandwiched between the pixel electrode 19 and an opposite electrode 16. Furthermore, one end of the storage capacitor Cst 20 is connected to the pixel electrode 19 and the other end of the storage capacitor Cst 20 is connected to a common electrode 17. Furthermore, the gate of the pixel transistor 18 is connected to the gate signal line 15, the source of the pixel transistor is connected to the source signal line 13 and the drain of the pixel transistor 18 is connected to the pixel electrode 19. Furthermore, a Clc 21 is a capacitor formed of the pixel electrode 19, the opposite electrode 16 and the liquid crystal layer in the OCB mode, a Cgs 23 is a capacitor formed of the gate and source of the pixel transistor 18 and a Cgd 22 is a capacitor formed of the gate and drain of the pixel transistor 18.

The “pixel” in the following descriptions will refer to the part consisting of the pixel electrode 19, pixel transistor 18, storage capacitor Cst 20, portion of the opposite electrode 16 facing the pixel electrode 19 and liquid crystal layer in the OCB mode sandwiched by portion of the opposite electrode 16 facing the pixel electrode 19 and the pixel electrode 19.

FIG. 15(a) illustrates each pixel in the direction of the source signal line 13. There is a queue of pixels g1, g2, . . . , g12, . . . in the direction of the source signal line 13.

FIG. 15(b) illustrates timings when each pixel in FIG. 15(a) is displayed through a 1.25-fold speed conversion. In FIG. 15(b), periods each indicating a 1 horizontal scanning period are expressed by T1, T2, . . . T10 . . . .

The 1.25-fold speed conversion converts an originally 4H video period to a 1.25-fold speed. That is, a 5H video period is provided in the originally 4H video period. Then, a black color is shown during the first 1H video period of the 5H video period and display colors are shown during the remaining 4H video period. Therefore, the 1H video period converted to the 1.25-fold speed is shortened to 0.8 times the original 1H video period. Such a 1.25-fold speed conversion is carried out by a controller circuit 6.

During a 1 horizontal scanning period T1, the black insertion voltage generation circuit 101 writes voltages corresponding to the black color into the four pixels g5, g6, g7, g8 simultaneously. That is, the switches 25 connected to the source signal lines 13 to which these four pixels are connected are switched in such a way that the black insertion voltage generation circuit 101 is connected to the source signal line 13 to which these four pixels are connected. Therefore, voltages corresponding to the black color are applied to these four pixels from the black insertion voltage generation circuit 101.

During the next 1 horizontal scanning period T2, the source driver 11 applies a voltage corresponding to a display color to the pixel g1. That is, the switch 25 connected to the source signal lines 13 to which the pixel g1 is connected is switched in such a way that the source driver 11 is connected to the source signal line 13 to which the pixel g1 is connected. Therefore, the source driver 11 applies the voltage corresponding to the display color to the pixel g1.

Likewise, during a 1 horizontal scanning period T3, a voltage corresponding to the display color is applied to the pixel g2. Then, during a 1 horizontal scanning period T4, a voltage corresponding to the display color is applied to the pixel g3. During a 1 horizontal scanning period T5, a voltage corresponding to the display color is applied to the pixel g4.

Furthermore, during a 1 horizontal scanning period T6, voltages corresponding to the black color are applied to the pixels g9, g10, g11, g12. During 1 horizontal scanning periods T7, T8, T9, T10, voltages corresponding to the display color are applied to the pixel g5, g6, g7, g8 respectively.

By repeating the above described operation, a 1.25-fold speed conversion is performed. Counter-transfer prevention is realized by applying voltages corresponding to the black color to four pixels during 1 horizontal scanning periods T1, T6, etc., through the black insertion voltage generation circuit 101. Thus, by performing a 1.25-fold speed conversion, it is possible to prevent counter-transfer even when a voltage of 2 V or less is applied to pixels.

In a 1.25-fold speed conversion, the speed at which each pixel is displayed becomes 1.25 times the speed when no counter-transfer prevention drive is performed. Thus, the 1.25-fold speed conversion eliminates the necessity to drive each pixel at a high speed as in the case of a double-speed conversion, and therefore it is possible to easily drive the liquid crystal display device and also achieve high contrast as the liquid crystal display device as in the case of the double-speed conversion.

However, when the temperature is as low as 10° C. or below, if each pixel of the liquid crystal display device is displayed, for example, in the same halftone color, streaks which are more blackish than the original display color appear every four lines on the display surface of the liquid crystal display panel as shown in FIG. 16(b). This is attributable to the following causes.

That is, FIG. 16(a) shows a voltage waveform of the source signal line 13. As is observed from this source voltage waveform, in order to prevent counter-transfer, a voltage corresponding to the black color is applied and then a voltage is written into the next pixel, and therefore even if a voltage corresponding to a halftone color is applied to the source signal line 13, the voltage of the source signal line 13 is not a voltage corresponding to the halftone color.

When the temperature is low, the capacitance of the liquid crystal increases, and therefore insufficient writing to the source line occurs. That is, even if a voltage corresponding to the black color is applied in order to prevent counter-transfer and then a voltage corresponding to the halftone color is applied to the next pixel, the source signal line 13 does not reach the voltage corresponding to the halftone color due to a parasitic capacitance, etc., of the source signal line 13. When the voltage corresponding to the halftone color is applied to the next pixel, the voltage of the source signal line 13 considerably approximates to the voltage corresponding to the halftone color, and therefore the source signal line 13 becomes the voltage corresponding to the halftone color. Thus, the pixels to which the voltages corresponding to the halftone color are applied immediately after writing the voltage corresponding to the black color for prevention of counter-transfer are displayed in black due to insufficient charge.

This problem that streaks which are more blackish than the original display color appear when the same halftone color is displayed on each pixel is not limited to a 1.25-fold speed conversion whereby the voltage corresponding to the black color is applied to four pixels simultaneously to prevent counter-transfer and then voltages corresponding to the respective display colors are sequentially applied to the four pixels. The same problem also occurs with a counter-transfer prevention drive whereby voltages corresponding to the black color are applied to n pixels simultaneously to prevent counter-transfer and then voltages corresponding to the respective display colors are sequentially applied to the n pixels. Furthermore, the same problem also occurs when each pixel is displayed not only with halftone colors but also with white color.

That is, when a counter-transfer prevention drive is performed through a liquid crystal display device using the OCB mode and the temperature is low, if each pixel is displayed in the same color such as a halftone color or white color, there is a problem that streaks which are more blackish than the original display color are displayed on the display surface of the display panel.

In view of the above described problems, it is an object of the present invention to provide a liquid crystal display device free of streaks which are more blackish than the original display color displayed on the display surface of the display panel even when the temperature is low or when each pixel is displayed in the same color such as a halftone color or white color and a method of driving the liquid crystal display device.

### SUMMARY OF THE INVENTION

The 1^{st} aspect of the present invention is a liquid crystal display device comprising:
a liquid crystal display panel having source signal lines and gate signal lines arranged in matrix form and liquid crystal display elements using OCB mode liquid crystal, said liquid crystal display elements being provided at intersections between said source signal lines and gate signal lines;
a gate driver that supplies a gate signal to said gate signal lines;
a source driver that supplies a voltage corresponding to gradation of display data to said source signal lines during a display period; and
a black insertion voltage generation circuit that supplies a voltage to prevent counter-transfer to said source signal lines during a counter-transfer prevention drive period,
wherein a voltage of source signal lines is supplied with a voltage adjusted to a voltage value corresponding to predetermined voltage value (1) during a period after said black insertion voltage generation circuit supplies said voltage to prevent counter-transfer in said counter-transfer prevention drive period or (2) during a period before the voltage corresponding to the gradation of display data is supplied to said source signal lines in said display period.

The 2^{nd} aspect of the present invention is the liquid crystal display device according to the 1^{st} aspect of the present invention, wherein said voltage adjusted to a voltage value corresponding to predetermined voltage value means such a voltage that a voltage of said source signal lines becomes a voltage corresponding to a halftone color.

The 3^{rd} aspect of the present invention is the liquid crystal display device according to the 2^{nd} aspect of the present invention, wherein said black insertion voltage generation circuit supplies, as the voltage to be supplied to prevent counter-transfer during said counter-transfer prevention drive period, a voltage according to the voltage corresponding to the gradation of said display data supplied to said source signal lines after the counter-transfer prevention drive period.

The 4^{th} aspect of the present invention is the liquid crystal display device according to the 2^{nd} aspect of the present invention, wherein said black insertion voltage generation circuit supplies, as the voltage supplied to prevent counter-transfer during said counter-transfer prevention drive period, a voltage according to a temperature.

The 5^{th} aspect of the present invention is the liquid crystal display device according to the 2^{nd} aspect of the present invention, wherein said black insertion voltage generation circuit may serves as said source driver.

The 6^{th} aspect of the present invention is the liquid crystal display device according to the 5^{th} aspect of the present invention, wherein in case said black insertion voltage generation circuit serves as said source driver, said source driver supplies, as the voltage supplied to prevent counter-transfer during said counter-transfer prevention dive period, a voltage according to the voltage corresponding to gradation of said display data supplied to said source signal lines after the counter-transfer prevention drive period.

The 7^{th} aspect of the present invention is the liquid crystal display device according to the 5^{th} aspect of the present invention, wherein in case said black insertion voltage generation circuit serves as said source driver, said source driver supplies, as the voltage supplied to prevent counter-transfer during said counter-transfer prevention drive period, a voltage according to a temperature.

The 8^{th} aspect of the present invention is the liquid crystal display device according to the 5^{th} aspect of the present invention, wherein in case said black insertion voltage generation circuit serves as said source driver, said source driver supplies such a voltage that a voltage of said source signal lines becomes the voltage corresponding to a halftone color to said source signal lines during a period after said source driver supplies said voltage to prevent counter-transfer in said counter-transfer prevention drive period.

The 9^{th} aspect of the present invention is the liquid crystal display device according to the 5^{th} aspect of the present invention, wherein in case said black insertion voltage generation circuit serves as said source driver, said source driver supplies such a voltage that a voltage of said source signal lines becomes the voltage corresponding to a halftone color to said source signal lines during a period after said source driver supplies said voltage to prevent counter-transfer in said counter-transfer prevention drive period.

The 10^{th} aspect of the present invention is the liquid crystal display device according to the 1^{st} aspect of the present invention, wherein in case a voltage of source signal lines is supplied with a voltage adjusted to a voltage value corresponding to predetermined voltage value during a period after said black insertion voltage generation circuit supplies said voltage to prevent counter-transfer in said counter-transfer prevention drive period,
that wherein said voltage of source signal lines is supplied with a voltage adjusted to a voltage value corresponding to predetermined voltage value means that, as the voltage corresponding to the gradation of said display data up to a predetermined number supplied to said source signal lines after said counter-transfer prevention drive period, such a voltage is supplied that the difference between said voltage to prevent counter-transfer and the voltage corresponding to the gradation of the display data up to said predetermined number is greater than the difference between said voltage to prevent counter-transfer and the voltage corresponding to the original display data.

The 11^{th} aspect of the present invention is the liquid crystal display device according to the 10^{th} aspect of the present invention, wherein said black insertion voltage generation circuit may serves as said source driver.

The 12^{th} aspect of the present invention is the liquid crystal display device according to the 1^{st} aspect of the present invention, wherein in case a voltage of source signal lines is supplied with a voltage adjusted to a voltage value corresponding to predetermined voltage value during a period after said black insertion voltage generation circuit supplies said voltage to prevent counter-transfer in said counter-transfer prevention drive period,
that wherein said voltage of source signal lines is supplied with a voltage adjusted to a voltage value corresponding to predetermined voltage value means that, as the voltage corresponding to the gradation of all said display data after a predetermined number supplied to said source signal lines after said counter-transfer prevention drive period, such a voltage is supplied that the difference between said voltage to prevent counter-transfer and the voltage corresponding to the gradation of said display data is smaller than the difference between said voltage to prevent counter-transfer and the voltage corresponding to the original display data.

The 13^{th} aspect of the present invention is the liquid crystal display device according to the 12^{th} aspect of the present invention, wherein said black insertion voltage generation circuit may serves as said source driver.

The 14^{th} aspect of the present invention is the liquid crystal display device according to the 1^{st} aspect of the present invention, wherein in case a voltage of source signal lines is supplied with a voltage adjusted to a voltage value corresponding to predetermined voltage value during a period after said black insertion voltage generation circuit supplies said voltage to prevent counter-transfer in said counter-transfer prevention drive period,
that wherein said voltage of source signal lines is supplied with a voltage adjusted to a voltage value corresponding to predetermined voltage value means that said display period corresponding to said display data up to a predetermined number supplied to said source signal lines after said counter-transfer prevention drive period is longer than said display period corresponding to said display data after said predetermined number.

The 15^{th} aspect of the present invention is the liquid crystal display device according to the 14^{th} aspect of the present invention, wherein said black insertion voltage generation circuit may serves as said source driver.

The 16^{th} aspect of the present invention is a method of driving a liquid crystal display device, said liquid crystal display device comprising:
a liquid crystal display panel having source signal lines and gate signal lines arranged in matrix form and liquid crystal display elements using OCB mode liquid crystal, said liquid crystal display elements being provided at intersections between said source signal lines and gate signal lines;
a gate driver that supplies a gate signal to said gate signal lines;
a source driver that supplies a voltage corresponding to gradation of display data to said source signal lines during a display period; and
a black insertion voltage generation circuit that supplies a voltage to prevent counter-transfer to said source signal lines during a counter-transfer prevention drive period, said method comprising a step of supplying a voltage of source signal lines with a voltage adjusted to a voltage value corresponding to predetermined voltage value (1) during a period after said black insertion voltage generation circuit supplies said voltage to prevent counter-transfer in said counter-transfer prevention drive period or (2) during a period before the voltage corresponding to the gradation of display data is supplied to said source signal lines in said display period.

The 17^{th} aspect of the present invention is the method of driving a liquid crystal display device, according to the 16^{th} aspect of the present invention, wherein said voltage adjusted to a voltage value corresponding to predetermined voltage value means such a voltage that said source signal lines becomes a voltage corresponding to a halftone color.

The 18^{th} aspect of the present invention is the method of driving a liquid crystal display device, according to the 17^{th} aspect of the present invention, wherein said black insertion voltage generation circuit may serves as said source driver.

The 19^{th} aspect of the present invention is the method of driving a liquid crystal display device, according to the 16^{th} aspect of the present invention, wherein in case a voltage of source signal lines is supplied with a voltage adjusted to a voltage value corresponding to predetermined voltage value during a period after said black insertion voltage generation circuit supplies said voltage to prevent counter-transfer in said counter-transfer prevention drive period,
that wherein said voltage of source signal lines is supplied with a voltage adjusted to a voltage value corresponding to predetermined voltage value means that, as the voltage corresponding to the gradation of said display data up to a predetermined number supplied to said source signal lines after said counter-transfer prevention drive period, such a voltage is supplied that the difference between said voltage to prevent counter-transfer and the voltage corresponding to the gradation of the display data up to said predetermined number is greater than the difference between said voltage to prevent counter-transfer and the voltage corresponding to the original display data.

The 20^{th} aspect of the present invention is the method of driving a liquid crystal display device, according to the 19^{th} aspect of the present invention, wherein said black insertion voltage generation circuit may serves as said source driver.

The 21^{st} aspect of the present invention is the method of driving a liquid crystal display device, according to the 16^{th} aspect of the present invention, wherein in case a voltage of source signal lines is supplied with a voltage adjusted to a voltage value corresponding to predetermined voltage value during a period after said black insertion voltage generation circuit supplies said voltage to prevent counter-transfer in said counter-transfer prevention drive period,
that wherein said voltage of source signal lines is supplied with a voltage adjusted to a voltage value corresponding to predetermined voltage value means that, as the voltage corresponding to the gradation of all said display data after a predetermined number supplied to said source signal lines after said counter-transfer prevention drive period, such a voltage is supplied that the difference between said voltage to prevent counter-transfer and the voltage corresponding to the gradation of said display data is smaller than the difference between said voltage to prevent counter-transfer and the voltage corresponding to the original display data.

The 22^{nd} aspect of the present invention is the method of driving a liquid crystal display device, according to the 21^{th} aspect of the present invention, wherein said black insertion voltage generation circuit may serves as said source driver.

The 23^{rd} aspect of the present invention is the method of driving a liquid crystal display device, according to the 16^{th} aspect of the present invention, wherein in case a voltage of source signal lines is supplied with a voltage adjusted to a voltage value corresponding to predetermined voltage value during a period after said black insertion voltage generation circuit supplies said voltage to prevent counter-transfer in said counter-transfer prevention drive period,
that wherein said voltage of source signal lines is supplied with a voltage adjusted to a voltage value corresponding to predetermined voltage value means that said display period corresponding to said display data up to a predetermined number supplied to said source signal lines after said counter-transfer prevention drive period is longer than said display period corresponding to said display data after said predetermined number.

The 24^{th} aspect of the present invention is the method of driving a liquid crystal display device, according to the 23^{rd} aspect of the present invention, wherein said black insertion voltage generation circuit may serves as said source driver.

The present invention can provide a liquid crystal display device free of streaks which are more blackish than the original display color displayed on the display surface of the display panel even when the temperature is low or when each pixel is displayed in the same color such as a halftone color or white color and a method of driving the liquid crystal display device.

### BRIEF DESCRIPTION OF THE DRAWINGS

FIG. 1 is a block diagram showing the configuration of a liquid crystal display device using an OCB mode according to first to fifth embodiments of the present invention;

FIG. 2 illustrates the vicinity of 1 pixel, a source driver and a black insertion voltage generation circuit of a liquid crystal display panel of a liquid crystal display device using an OCB mode according to the first to fifth embodiments of the present invention;

FIG. 3(a) illustrates a voltage waveform of a source signal line of a liquid crystal display device using the OCB mode according to the first embodiment of the present invention and FIG. 3(b) illustrates a display surface of the liquid crystal display panel of the liquid crystal display device using the OCB mode according to the first embodiment of the present invention;

FIG. 4(a) illustrates a voltage waveform of a source signal line of a liquid crystal display device using an OCB mode according to a second embodiment of the present invention and a conductivity state of a switch 26 of a black insertion voltage generation circuit and FIG. 4(b) illustrates the black insertion voltage generation circuit according to the second embodiment of the present invention;

FIG. 5 illustrates a voltage waveform of a source signal line and an output voltage of a source driver of another liquid crystal display device using the OCB mode according to the second embodiment of the present invention;

FIG. 6 illustrates a voltage waveform of a source signal line and an output voltage of a black insertion voltage generation circuit of another liquid crystal display device using the OCB mode according to the second embodiment of the present invention;

FIG. 7(a) illustrates a method of gradation correction carried out by a source driver according to a third embodiment of the present invention, FIG. 7(b) illustrates a display state of the display surface of the liquid crystal display panel when the source driver does not carry out gradation correction and FIG. 7(c) illustrates a display state of the display surface of the liquid crystal display panel when the source driver carries out gradation correction;

FIG. 8(a) illustrates another method of gradation correction carried out by the source driver according to the third embodiment of the present invention, FIG. 8(b) illustrates a display state of the display surface of the liquid crystal display panel when the source driver does not carry out gradation correction and FIG. 8(c) illustrates a display state of the display surface of the liquid crystal display panel when the source driver carries out gradation correction;

FIG. 9 illustrates the vicinity of 1 pixel, a source driver and a black insertion voltage generation circuit of a liquid crystal display panel of a liquid crystal display device using an OCB mode according to a fourth embodiment of the present invention;

FIG. 10 illustrates a method of obtaining an amount of gradation adjustment from the gradation corresponding to a black color according to the fourth embodiment of the present invention;

FIG. 11 (a) illustrates the respective pixels arranged in the direction of a source signal line of a liquid crystal display device using an OCB mode according to a fifth embodiment of the present invention and FIG. 11(b) illustrates timings when each pixel of FIG. 11(a) according to the fifth embodiment of the present invention is displayed through a 1.25-fold speed conversion;

FIG. 12 illustrates a voltage waveform of the source signal line of the liquid crystal display device using the OCB mode of this embodiment;

FIG. 13(a) illustrates a schematic cross-sectional view of a conventional liquid crystal display panel making up a liquid crystal display device using an OCB mode when a voltage is applied, FIG. 13(b) illustrates a schematic cross-sectional view of the conventional liquid crystal display panel making up the liquid crystal display device using the OCB mode when a voltage is applied and FIG. 13(c) illustrates a schematic cross-sectional view of the conventional liquid crystal display panel making up the liquid crystal display device using the OCB mode when no voltage is applied;

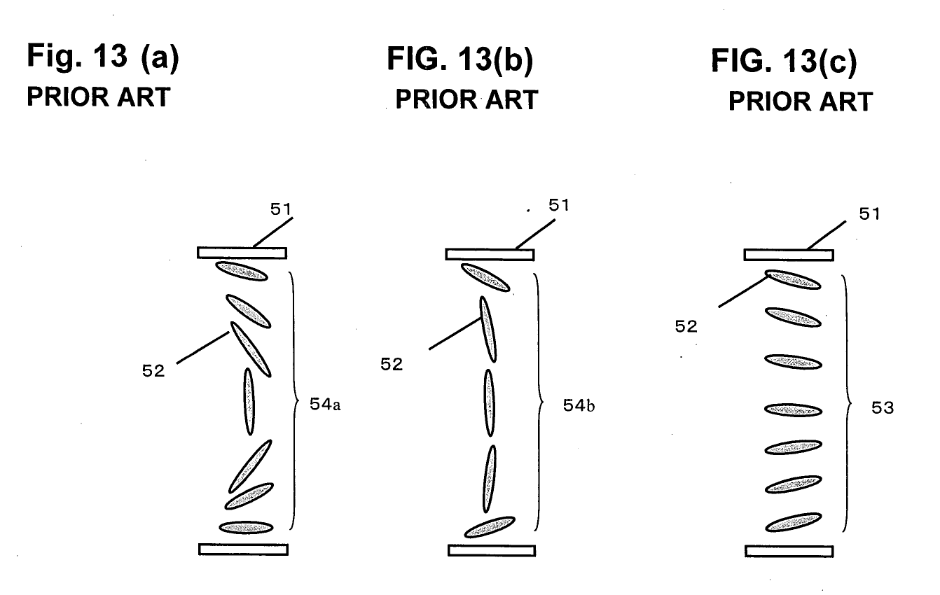

FIG. 14 illustrates the vicinity of 1 pixel, a source driver and a black insertion voltage generation circuit of a liquid crystal display panel making up a liquid crystal display device using a conventional OCB mode;

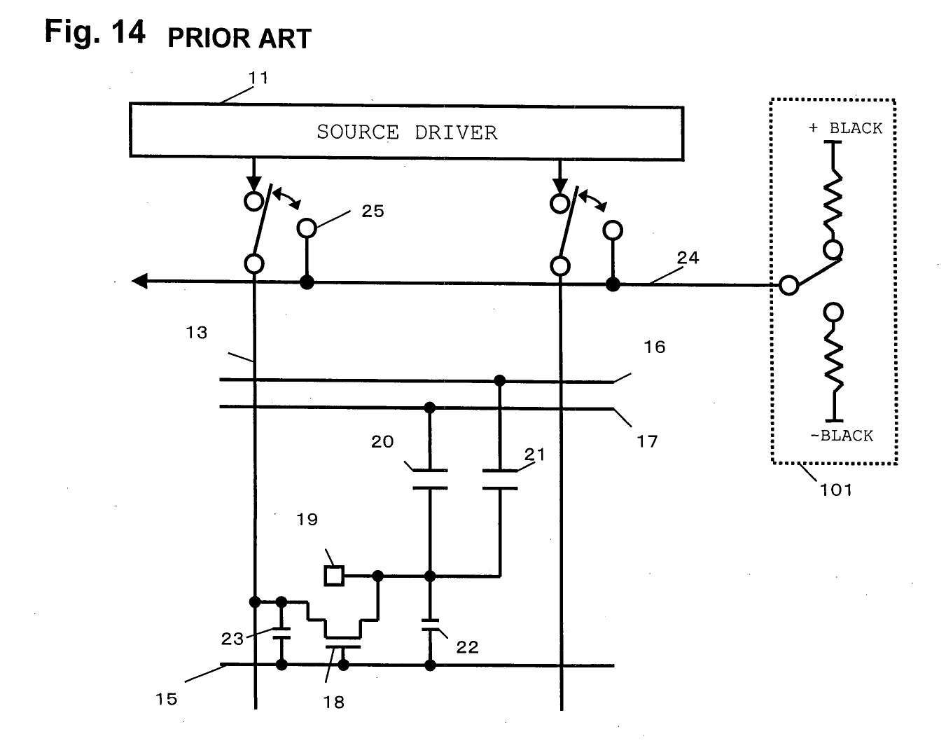

FIG. 15(a) illustrates the respective pixels arranged in the direction of a source signal line of a liquid crystal display device using an OCB mode according to an embodiment of the present invention and conventional example and FIG. 15(b) illustrates timings when each pixel according to the embodiment of the present invention and conventional example is displayed through a 1.25-fold speed conversion; and

FIG. 16(a) illustrates a voltage waveform of a source signal line of a conventional liquid crystal display device using the OCB mode and FIG. 16(b) illustrates a display state on the display surface of the liquid crystal display panel of the conventional liquid crystal display device using the OCB mode.

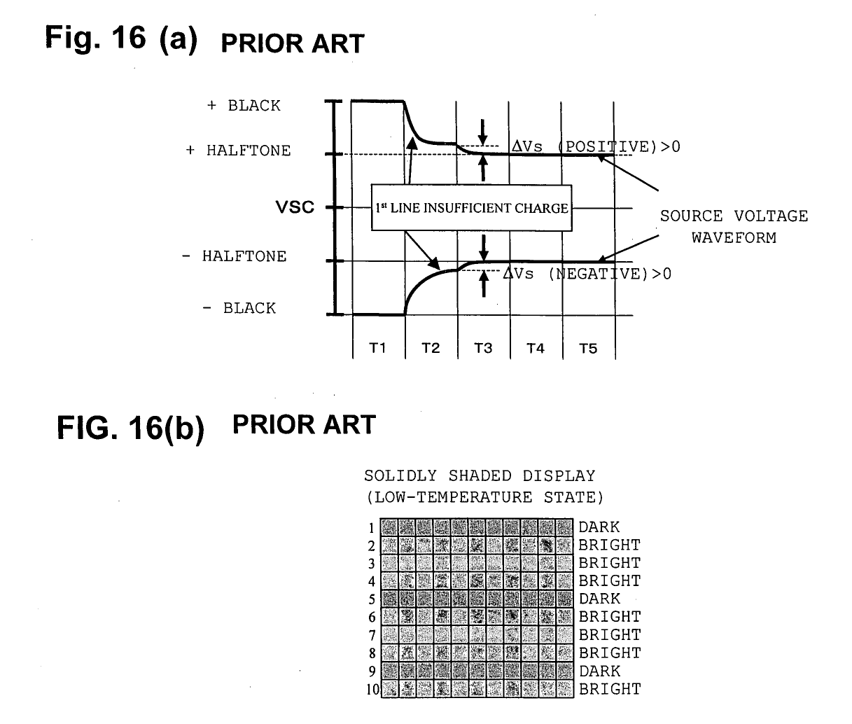

### DESCRIPTION OF REFERENCE NUMERALS

1 Liquid crystal display device
2 Liquid crystal display panel
3 Gate driver
5 Liquid crystal drive voltage generation circuit
6 Controller circuit
8 Input power supply
11 Source driver
12 Black insertion voltage generation circuit
13 Source signal line
15 Gate signal line
16 Opposite electrode
17 Common electrode
18 Pixel transistor
19 Pixel electrode
20 Storage capacitor Cst
14 Black insertion voltage generation circuit
25 Switch
26 Switch
51 Glass substrate
52 Liquid crystal molecule
53 Spray state
54a Bent state
54b Bent state

### PREFERRED EMBODIMENTS OF THE INVENTION

With reference now to the attached drawings, embodiments of the present invention will be explained below.

### First Embodiment

First, a first embodiment will be explained.

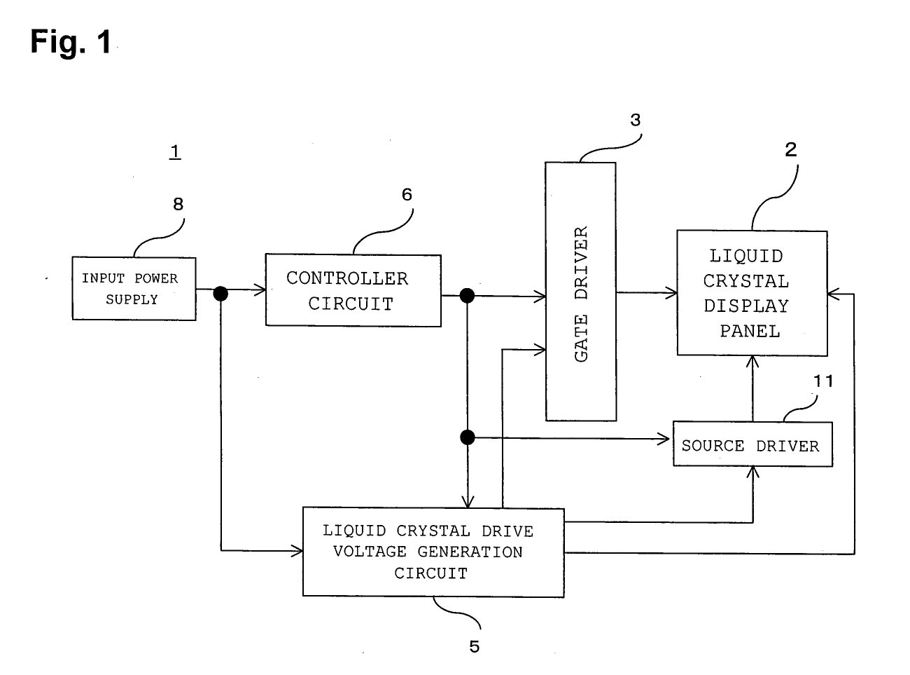

FIG. 1 shows a block diagram of a liquid crystal play device using an OCB mode of a first embodiment.

A liquid crystal display device 1 is a liquid crystal play device using OCB mode liquid crystal.

The liquid crystal display device 1 is constructed of a liquid crystal display panel 2, a gate driver 3, a source driver 11, a liquid crystal drive voltage generation circuit 5, a controller circuit 6 and an input power supply 8.

The liquid crystal display panel 2 is a display panel having source signal lines and gate signal lines arranged in matrix form and pixels provided at intersections between the source signal lines and gate signal lines and using OCB mode liquid crystal.

The gate driver 3 is a circuit that supplies a selection scanning signal for carrying out linear sequential scanning of each gate signal line of the liquid crystal display panel 2.

The source driver 11 is a circuit that supplies each source signal line of the liquid crystal display panel 2 with an image signal voltage.

The liquid crystal drive voltage generation circuit 5 is a circuit that supplies a source driver drive voltage to the source driver 11, supplies a gate driver drive voltage to the gate driver 3 and supplies an opposite signal electrode drive voltage to the opposite signal electrode.

The controller circuit 6 is a circuit that controls image signal processing and drive timing. The controller circuit 6 is a circuit that inputs display data, outputs a display signal corresponding to the display data and sends timing control signals to the source driver 11, gate driver 3 and liquid crystal drive voltage generation circuit 5.

The input power supply 8 is means of supplying power for the liquid crystal display device 1 to operate.

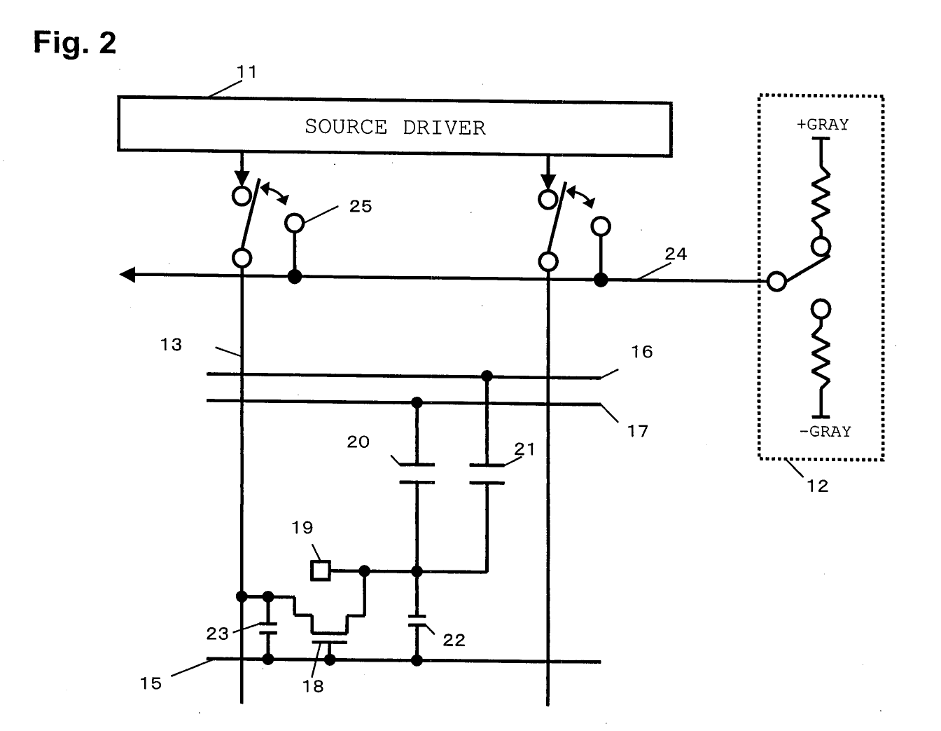

FIG. 2 illustrates the vicinity of 1 pixel, the source driver 11 and a black insertion voltage generation circuit 12 of the liquid crystal display panel 2 of the liquid crystal display device using an OCB mode.

A source signal line 13 is connected to the source driver 11 through a switch 25 and a gate signal line 15 is connected to the gate driver 3. Furthermore, a precharge line 24 is connected to each source signal line 13 through each switch 25. The precharge line 24 is connected to the black insertion voltage generation circuit 12.

That is, the switch 25 allows the source signal line 13 to select whether to be connected to the source driver 11 or connected to the black insertion voltage generation circuit 12 through the precharge line 24.

At the intersection between the source signal line 13 and gate signal line 15, a pixel transistor 18, a pixel electrode 19 and a storage capacitor Cst 20 for adding a compensation potential are formed and an OCB mode liquid crystal layer (not shown) is sandwiched between the pixel electrode 19 and opposite electrode 16. Furthermore, one end of the storage capacitor Cst 20 is connected to the pixel electrode 19 and the other end of the storage capacitor Cst 20 is connected to a common electrode 17. Furthermore, the gate of the pixel transistor 18 is connected to the gate signal line 15 and the source of the pixel transistor is connected to the source signal line 13 and the drain of the pixel transistor 18 is connected to the pixel electrode 19.

Furthermore, a Clc 21 is a capacitance formed of the pixel electrode 19, opposite electrode 16 and OCB mode liquid crystal layer, a Cgs 23 is a capacitance formed between the gate and source of the pixel transistor 18 and a Cgd 22 is a capacitance formed between the gate and drain of the pixel transistor 18.

The “pixel” in the following descriptions will refer to the part consisting of the pixel electrode 19, pixel transistor 18, storage capacitor Cst 20, portion of the opposite electrode 16 facing the pixel electrode 19 and liquid crystal layer in the OCB mode sandwiched by portion of the opposite electrode 16 facing the pixel electrode 19 and the pixel electrode 19.

The pixel in this embodiment is an example of the liquid crystal display element of the present invention. Such a voltage that a voltage of said source signal lines becomes a voltage corresponding to a halftone color in this embodiment is an example of the predetermined voltage of the present invention.

Next, the operation of this embodiment will be explained.

The input power supply 8 is supplied to the controller circuit 6 and liquid crystal drive voltage generation circuit 5 and the controller circuit 6 is started first. Then, the controller circuit 6 sends an image display signal and timing control signal to the source driver 11, sends a timing control signal to the gate driver 3 and sends a timing control signal to the liquid crystal drive voltage generation circuit 5.

The liquid crystal drive voltage generation circuit 5 supplies a source driver drive voltage to the source driver 11, supplies a gate driver drive voltage to the gate driver 3 and supplies an opposite signal electrode drive voltage to the opposite signal electrode. A voltage for transfer drive of 20 V to 25 V is applied to each pixel for a predetermined time from the opposite electrode. Thus, the OCB mode liquid crystal of the liquid crystal display panel 2 transitions from a spray state to a bent state, allowing a display operation of the liquid crystal display device.

When a display operation is carried out, the liquid crystal display device using the OCB mode of this embodiment also performs a 1.25-fold speed conversion as a counter-transfer prevention drive as in the case of the liquid crystal display device explained in the conventional technology. Furthermore, suppose the temperature of the liquid crystal display panel 2 is as low as, for example, 10° C. or less.

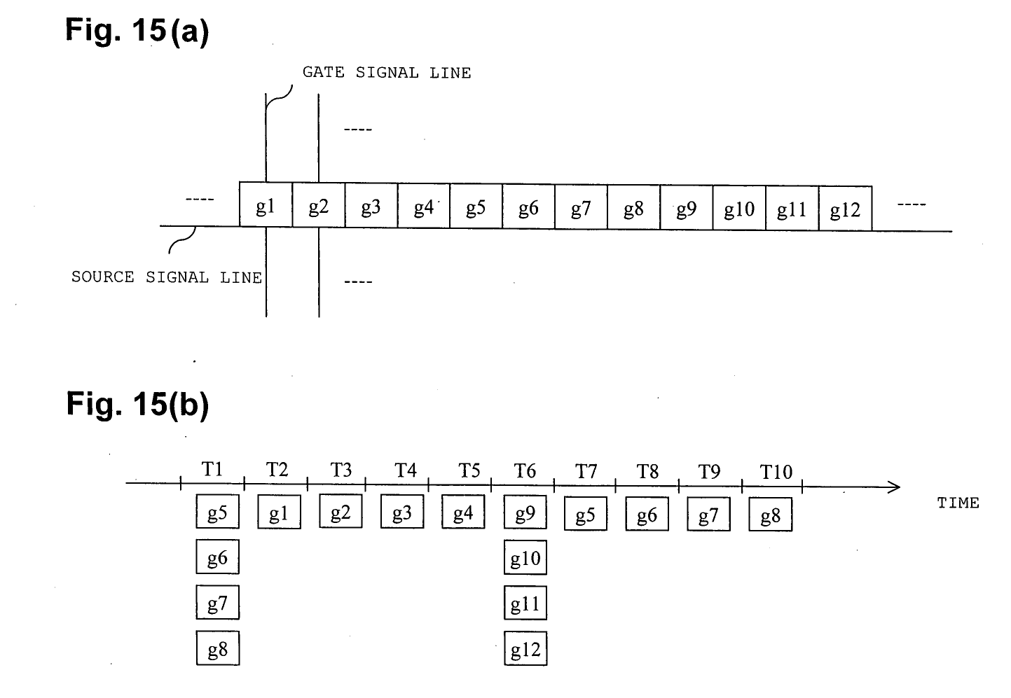

That is, FIG. 15(a) illustrates each pixel in the direction of the source signal line 13. There is a queue of pixels g1, g2, . . . , g12, . . . in the direction of the source signal line 13.

FIG. 15(b) illustrates timings when each pixel in FIG. 15(a) is displayed through a 1.25-fold speed conversion. In FIG. 15(b), periods each indicating a 1 horizontal scanning period are expressed by T1, T2, T10. FIGS. 15(a), (b) have already been explained in the conventional technology and explanations thereof will be omitted.

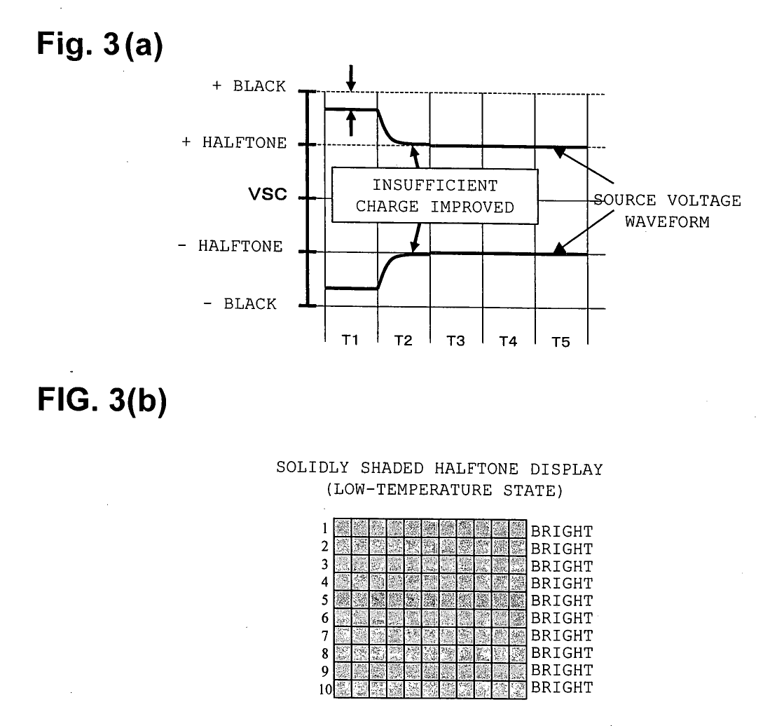

FIG. 3(a) illustrates a voltage waveform of the source signal line of 13 the liquid crystal display device using the OCB mode according to this embodiment. The voltage waveform of the source signal line 13 in FIG. 3(a) is a voltage waveform when the same halftone color is displayed on each pixel. Furthermore, the horizontal axis of the voltage waveform of the source signal line 13 in FIG. 3(a) shows 1 horizontal scanning periods T1, T2, T3, T4 and T5 shown in FIG. 15(b).

As is observed from the source voltage waveform in FIG. 3(a), the voltage of the source signal line 13 during 1 horizontal scanning period T1, that is, a period during which a drive for preventing counter-transfer is performed is set to a voltage lower than the voltage corresponding to the black color unlike the conventional technology. The voltage of the source signal line 13 during a 1 horizontal scanning period T2, that is, a period during which a halftone color is displayed is set to a voltage corresponding to the halftone color.

Likewise, all voltages of the source signal line 13 during 1 horizontal scanning periods T3, T4, T5, that is, periods during which the halftone color is displayed are set to the voltage corresponding to the halftone color.

Thus, unlike the conventional technology, the black insertion voltage generation circuit 12 of this embodiment supplies a voltage lower by a predetermined value than the voltage corresponding to the black color as the voltage to prevent counter-transfer. That is, since the liquid crystal display device of this embodiment is driven by AC, to be exact, the black insertion voltage generation circuit 12 supplies a voltage whose absolute value is smaller than the absolute value of the voltage corresponding to the black color as the voltage to prevent counter-transfer. Therefore, when a voltage whose absolute value is smaller by a predetermined value than the voltage corresponding to the black color to prevent counter-transfer is applied and then the voltage is written to the next pixel, it is possible to set the voltage of the source signal line 13 to a voltage corresponding to the halftone color.

Thus, streaks which are more blackish than the original display color are no longer displayed on the display surface of the liquid crystal display panel 2 as shown in FIG. 3(b).

As shown above, according to this embodiment, the black insertion voltage generation circuit 12 supplies a voltage whose absolute value is smaller by a predetermined value than the voltage corresponding to the black color, and can thereby compensate for the insufficient charge of the source signal line 13.

This embodiment has been explained assuming that the black insertion voltage generation circuit 12 supplies a voltage whose absolute value is smaller by a predetermined value than the voltage corresponding to the black color, but suppose that as such a predetermined value, a value is used which will prevent streaks which are more blackish than the original display color from being displayed no matter what gradation of the color to be displayed during the 1 horizontal scanning period T2 following the 1 horizontal scanning period T1 may have. Furthermore, it is also possible to determine such a predetermined value depending on the gradation of the color to be displayed during the 1 horizontal scanning period T2 following the 1 horizontal scanning period T1 or depending on the temperature, which case will be explained in more detail in a fourth embodiment which will be described later.

This embodiment has explained the case where the same halftone color is displayed on each pixel when 1.25-fold speed conversion is performed as a counter-transfer prevention drive, but the present invention is not limited to this. A counter-transfer prevention drive which applies a voltage corresponding to the black color to n pixels simultaneously to prevent counter-transfer and then applies voltages corresponding to display colors to n pixels sequentially can also achieve similar effects as those of this embodiment. Furthermore, when each pixel is displayed in not only halftone color but also white color, it is possible to achieve similar effects as those of this embodiment.

Furthermore, this embodiment has been explained assuming that the black insertion voltage generation circuit 12 applies a voltage whose absolute value is smaller by a predetermined value than the voltage corresponding to the black color to prevent counter-transfer, but the present invention is not limited to this. It is also possible not to provide the black insertion voltage generation circuit 12 and to allow the source driver 11 instead of the black insertion voltage generation circuit 12 to apply a voltage lower by a predetermined value than the voltage corresponding to the black color to prevent counter-transfer. The black insertion voltage generation circuit 12 may serve as the source driver 11, and the source driver 11 may serve as the black insertion voltage generation circuit 12.

### Second Embodiment

Next, a second embodiment will be explained.

The configuration of a liquid crystal display device using an OCB mode according to a second embodiment is shown in FIG. 1 in the same way as the first embodiment.

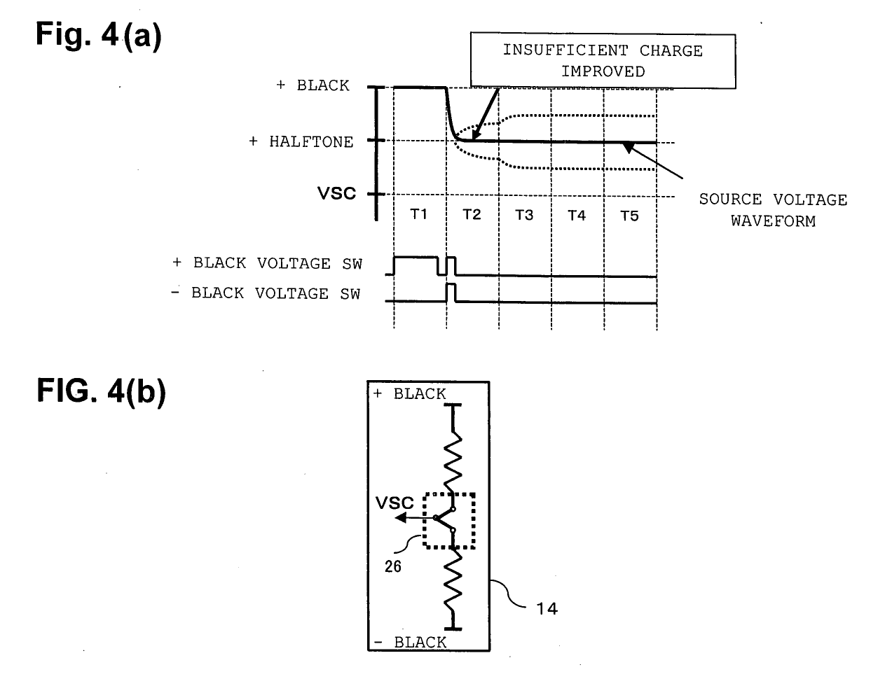

The difference between the liquid crystal display device using the OCB mode according to the second embodiment and the liquid crystal display device using the OCB mode according to the first embodiment is that the device in the second embodiment is provided with a black insertion voltage generation circuit 14 shown in FIG. 4(b) instead of the black insertion voltage generation circuit 12 in FIG. 2.

The black insertion voltage generation circuit 14 is a circuit that can have, according to the switch 26, three states; a state in which the source signal line 13 is connected to the supply side of the positive black insertion voltage, a state in which the source signal line 13 is connected to the supply side of the negative black insertion voltage and a state in which the source signal line 13 is connected to both the supply side of the positive black insertion voltage and the supply side of the negative black insertion voltage.

Next, the operation of this embodiment will be explained centered on the difference from the first embodiment.

When the display operation is performed, the liquid crystal display device using the OCB mode in this embodiment as well as the liquid crystal display device explained in the conventional technology carries out a 1.25-fold speed conversion as a counter-transfer prevention drive. Furthermore, suppose that the temperature of the liquid crystal display panel 2 is as low as, for example, 10° C. or less. Furthermore, a case where the same halftone color is displayed on the liquid crystal display panel 2 will be explained.

That is, FIG. 15(a) shows each pixel in the direction of the source signal line 13. There is a queue of pixels g1, g2, . . . , g12, . . . in the direction of the source signal line 13.

FIG. 15(b) illustrates timings when each pixel in FIG. 15(a) is displayed through a 1.25-fold speed conversion. In FIG. 15(b), periods which indicate a 1 horizontal scanning period respectively are expressed by T1, T2, . . . T10 . . . . FIGS. 15(a), (b) have already been explained in the conventional technology and explanations thereof will be omitted.

FIG. 4(a) illustrates a voltage waveform of the source signal line 13 of the liquid crystal display device using the OCB mode according to this embodiment and a conductivity state of a switch 26 of a black insertion voltage generation circuit 14. The voltage waveform of the source signal line 13 in FIG. 4(a) is a voltage waveform when the same halftone color is displayed on each pixel. Furthermore, the horizontal axis of the voltage waveform of the source signal line 13 in FIG. 4(a) shows 1 horizontal scanning periods T1, T2, T3, T4 and T5 shown in FIG. 15(b).

The switch 26 is switched so that the supply side of the positive black insertion voltage is electrically continuous with the source signal line 13 and the supply side of the negative black insertion voltage is not electrically continuous with the source signal line 13. Therefore, the positive voltage corresponding to the black color is applied to the source signal line 13 during the 1 horizontal scanning period T1.

Furthermore, in the 1 horizontal scanning period T2 before the source driver 11 supplies the voltage corresponding to a halftone color, the switch 26 is switched so that both the supply side of the positive black insertion voltage and the supply side of the negative black insertion voltage are connected to the source signal line 13. That is, the black insertion voltage generation circuit 14 is short-circuited. For this reason, the voltage resulting from short-circuiting the supply side of the positive black insertion voltage and the supply side of the negative black insertion voltage is supplied to the source signal line 13. Since the voltage resulting from short-circuiting the supply side of the positive black insertion voltage and the supply side of the negative black insertion voltage is a voltage corresponding to a white color, the voltage of the source signal line 13 becomes the voltage responding to the halftone color more quickly during the 1 horizontal scanning period T2. Then, the switch 26 is switched so that neither the supply side of the positive black insertion voltage nor the supply side of the negative black insertion voltage is electrically continuous to the source signal line 13 and the voltage corresponding to the halftone color is supplied from the source driver 11.

As is observed from the source voltage waveform in FIG. 4(a), during the 1 horizontal scanning period T1, that is, a period during which a drive for preventing counter-transfer is performed, the voltage corresponding to the black color is set as the voltage of the source signal line 13. During the 1 horizontal scanning period T2, that is, a period during which the halftone color is displayed, the voltage of the source signal line 13 is set to the voltage corresponding to the halftone color by short-circuiting the black insertion voltage generation circuit 14.

Likewise, all the voltages of the source signal line 13 during the 1 horizontal scanning periods T3, T4, T5, that is, periods during which the halftone color is displayed are set to the voltage corresponding to the halftone color.

Thus, the second embodiment short-circuits the black insertion voltage generation circuit 14 during part of the 1 horizontal scanning period T2, and can thereby charge also the pixel, after the voltage corresponding to the black color is applied as the voltage to prevent counter-transfer, to the voltage corresponding to the halftone color.

Thus, according to the second embodiment, by short-circuiting the black insertion voltage generation circuit 14 during a period before the voltage corresponding to the halftone color is supplied to the source signal line 13 out of the display period which is a period next to the counter-transfer prevention drive period, it is possible to supply the source signal line 13 with such a voltage that the voltage of the source signal line 13 becomes the voltage corresponding to the halftone color. Therefore, it is possible to set the source signal line 13 to the voltage corresponding to the halftone color during the 1 horizontal scanning period T2 which is the period next to the counter-transfer prevention drive period.

This embodiment has explained the case where the black insertion voltage generation circuit 14 is short-circuited during the 1 horizontal scanning period T2 which is the display period next to the 1 horizontal scanning period T1, that is, the counter-transfer prevention drive period but the present invention is not limited to this. Even if the black insertion voltage generation circuit 14 is short-circuited during a period after the black insertion voltage generation circuit 14 supplies a voltage to prevent counter-transfer in the counter-transfer prevention drive period, that is, 1 horizontal scanning period T1, it is possible to obtain effects similar to those of this embodiment.

This embodiment has explained the case where the black insertion voltage generation circuit 14 is short-circuited during the counter-transfer prevention drive period, that is, the 1 horizontal scanning period T2 which is the display period next to the 1 horizontal scanning period T1, but the present invention is not limited to this. It is also possible to supply the voltage corresponding to the halftone color from the source driver 11 for the period after the voltage corresponding to the black color is supplied from the black insertion voltage generation circuit 14 to the source signal line 13 in the 1 horizontal scanning period T1.

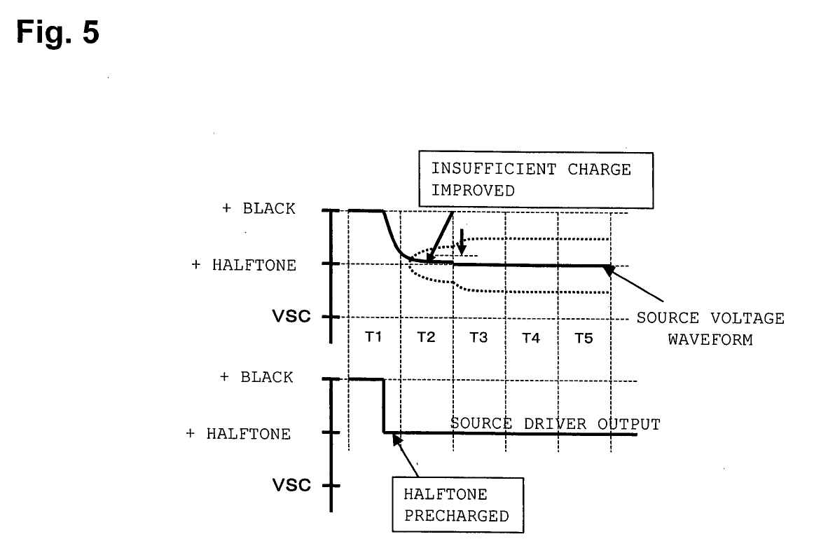

FIG. 5 shows a voltage waveform of the source signal line 13 and an output voltage of the source driver 11 of the liquid crystal display device using the OCB mode in such a case. The black insertion voltage generation circuit 14 supplies the voltage corresponding to the halftone color during a period after the voltage corresponding to the black color is supplied from the black insertion voltage generation circuit 14 to the source signal line 13 in the 1 horizontal scanning period T1 which is the counter-transfer prevention drive period. Therefore, as shown in FIG. 5, the voltage of the source signal line 13 is set to the voltage corresponding to the halftone color during the 1 horizontal scanning period T2 which is the period next to the 1 horizontal scanning period T1 which is the counter-transfer prevention drive period. Thus, since the source driver 11 supplies the source signal line 13 with such a voltage that the voltage of the source signal line 13 becomes the voltage corresponding to the halftone color for the period after the black insertion voltage generation circuit 14 supplies the voltage to prevent counter-transfer in the counter-transfer prevention drive period, it is possible to prevent streaks which are more blackish than the original display color from appearing on the display surface of the liquid crystal display panel 2.

Furthermore, this embodiment has explained the case where that the black insertion voltage generation circuit 14 is short-circuited for the counter-transfer prevention drive period, that is, 1 horizontal scanning period T2 which is the display period next to the 1 horizontal scanning period T1, but the present invention is not limited to this. It is also possible to supply the voltage corresponding to the halftone color from the black insertion voltage generation circuit 14 for the period after the voltage corresponding to the black color is supplied from the black insertion voltage generation circuit 14 to the source signal line 13 in the 1 horizontal scanning period T1.

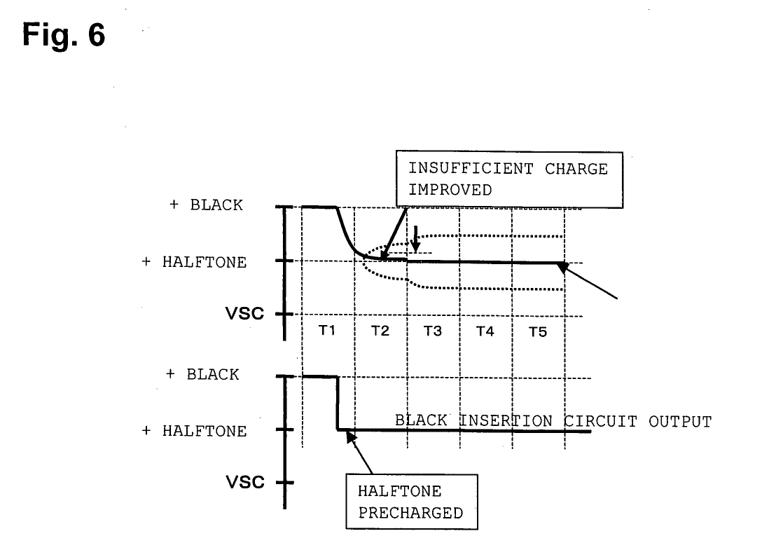

FIG. 6 shows a voltage waveform of the source signal line 13 and output voltage of the black insertion voltage generation circuit 14 of the liquid crystal display device using the OCB mode in such a case. The black insertion voltage generation circuit 14 supplies the voltage corresponding to the halftone color for a period after the voltage corresponding to the black color is supplied from the black insertion voltage generation circuit 14 to the source signal line 13 in the 1 horizontal scanning period which is the counter-transfer prevention drive period. Therefore, as shown in FIG. 6, the voltage of the source signal line 13 is set to the voltage corresponding to the halftone color for the 1 horizontal scanning period T2 which is the period next to the 1 horizontal scanning period T1 which is the counter-transfer prevention drive period. Thus, since the black insertion voltage generation circuit 14 supplies the source signal line 13 with such a voltage that the voltage of the source signal line 13 becomes the voltage corresponding to the halftone color for a period after the source driver 11 supplies the voltage to prevent counter-transfer out of the counter-transfer prevention drive period, and therefore it is possible to prevent streaks which are more blackish than the original display color from appearing on the display surface of the liquid crystal display panel 2.

Furthermore, this embodiment has explained the case where the same halftone color is displayed on each pixel when a 1.25-fold speed conversion is carried out as a counter-transfer prevention drive, but the present invention is not limited to this. Even a counter-transfer prevention drive which applies the voltage corresponding to the black color to prevent counter-transfer to n pixels simultaneously and then applies voltages corresponding to display colors to n pixels sequentially can obtain effects similar to those of this embodiment. Furthermore when each pixel is displayed in not only a halftone color but also white color, it is possible to obtain effects similar to those of this embodiment.

This embodiment has been explained assuming that the black insertion voltage generation circuit 14 performs a counter-transfer prevention drive, but the present invention is not limited to this. It is also possible not to provide any black insertion voltage generation circuit 14 and to allow the source driver 11 instead of the black insertion voltage generation circuit 14 to perform the counter-transfer prevention drive. In that case, the source driver 11 will assume the function carried out by the black insertion voltage generation circuit 14 instead of the black insertion voltage generation circuit 14. The black insertion voltage generation circuit 14 may serve as the source driver 11, and the source driver 11 may serve as the black insertion voltage generation circuit 14.

### Third Embodiment

Next, a third embodiment will be explained.

The configuration of a liquid crystal display device using an OCB mode according to a third embodiment is shown in FIG. 1 as in the case of the first embodiment.

FIG. 2 shows the vicinity of 1 pixel of the liquid crystal display panel 2, source driver 11 and black insertion voltage generation circuit 12 out of the liquid crystal display device using the OCB mode. However, Embodiment 1 has explained that the black insertion voltage generation circuit 12 supplies a voltage lower by a predetermined value than the voltage corresponding to the black color, but the third embodiment assumes that the black insertion voltage generation circuit 12 supplies a voltage corresponding to the black color.

The difference between the liquid crystal display device using the OCB mode according to the third embodiment and the liquid crystal display device using the OCB mode according to the first embodiment is that the source driver 11 carries out a gradation correction.

Next, the operation of this embodiment will be explained centered on the difference from the first embodiment.

When the display operation is performed, the liquid crystal display device using the OCB mode in this embodiment as well as the liquid crystal display device explained in the conventional technology carries out a 1.25-fold speed conversion as a counter-transfer prevention drive. Furthermore, suppose that the temperature of the liquid crystal display panel 2 is as low as, for example, 10° C. or less. Furthermore, a case where the same halftone color is displayed on the liquid crystal display panel 2 will be explained.

That is, FIG. 15(a) shows each pixel in the direction of the source signal line 13. There is a queue of pixels g1, g2, . . . , g12, . . . in the direction of the source signal line 13.

FIG. 15(b) illustrates timings when each pixel in FIG. 15(a) is displayed through a 1.25-fold speed conversion. In FIG. 15(b), periods each indicating a 1 horizontal scanning period are expressed by T1, T2, . . . T10 . . . . FIGS. 15(a), (b) have already been explained in the conventional technology and explanations thereof will be omitted.

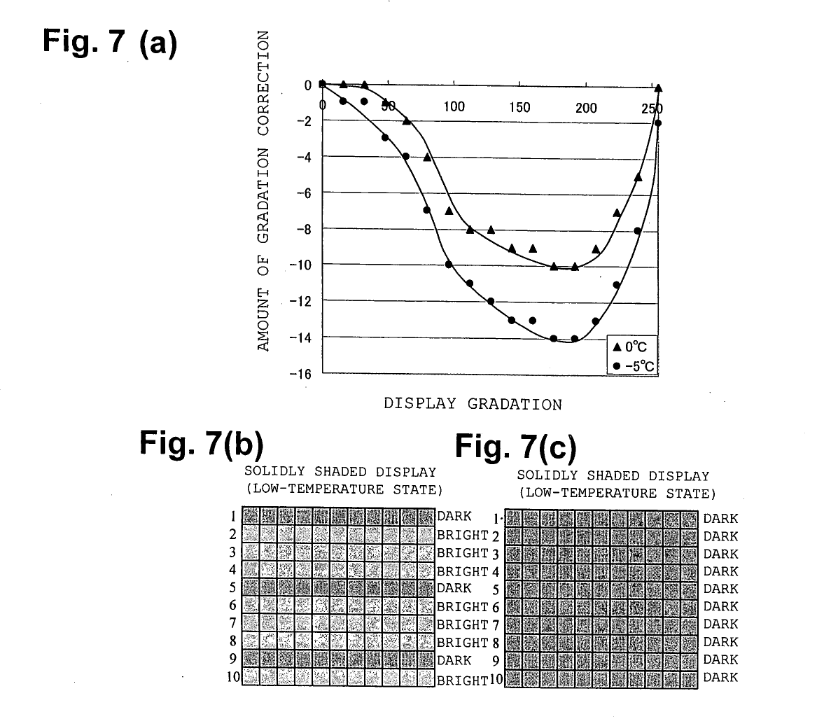

The source driver 11 of this embodiment corrects display gradation when the voltage corresponding to a halftone color is supplied during 1 horizontal scanning periods T3, T4, T5. That is, FIG. 7(a) shows such a method of correcting gradation. The graph in FIG. 7 is experimentally obtained to evaluate what extent of gradation correction should be carried out in each display gradation at each temperature. FIG. 7(a) shows that the amount of gradation correction increases as the temperature lowers and FIG. 7(a) shows that the gradation corresponding to the halftone color requires a greater amount of gradation correction than white gradation and black gradation.

For example, when the display gradation is 100, the source driver 11 corrects display gradation so that it is decreased by 7 when the temperature is 0° C. Therefore, in this case, the source driver 11 supplies a voltage corresponding to 93 to the source signal line 13 as display gradation. Furthermore, even when the display gradation is 100, if the temperature is −5° C., the source driver 11 corrects display gradation so that it is decreased by 10. Therefore, in this case, the source driver 11 supplies a voltage corresponding to 90 to the source signal line 13 as display gradation.

Thus, the source driver 11 corrects gradation of the display color according to the temperature and gradation during 1 horizontal scanning periods T3, T4, T5. The amount of gradation correction is a negative value.

That is, the black insertion voltage generation circuit 31 when the temperature is as low as, for example, 10° C. or below, the source driver 11 does not charge the pixel g1 corresponding to the 1 horizontal scanning period T2 up to the voltage corresponding to the halftone color. However, even in such a case, by carrying out gradation correction so that gradation of display colors during 1 horizontal scanning periods T3, T4, T5 becomes smaller, it is possible to prevent streaks which are more blackish than the original display color from appearing.

Therefore, as shown in FIG. 7(b), when gradation of display colors during 1 horizontal scanning periods T3, T4, T5 is not corrected, the pixel g1 to which the voltage corresponding to the display color during a 1 horizontal scanning period T2 is supplied becomes more blackish than the original display color. Therefore, streaks which are more blackish than the original display color appear on the display surface of the liquid crystal display panel 2. However, by carrying out the above described gradation correction, the entire screen becomes slightly more blackish than the original display color but it is possible to prevent streaks which are more blackish than the original display color from appearing.

This embodiment has been explained assuming that the source driver 11 corrects gradation of the display colors during 1 horizontal scanning periods T3, T4, T5 according to the temperature and gradation, but the present invention is not limited to this. When insufficient charge of the source signal line 13 occurs not only during the 1 horizontal scanning period T2 but also, for example, T3, the source driver 11 corrects gradation according to the insufficient charge during the 1 horizontal scanning period T3 and can correct gradation of the display colors for the 1 horizontal scanning periods T4, T5 according to the temperature and gradation. Thus, the source driver 11 corrects gradation of display colors during 1 horizontal scanning periods after the 1 horizontal scanning period during which the insufficient charge of the source signal line 13 occurs according to the temperature and gradation, and can thereby achieve effects equivalent to those of this embodiment. In short, as the voltage corresponding to the gradation of all said display data after a predetermined number supplied to said source signal lines, any voltage will do as long as such a voltage is supplied that the difference between said voltage to prevent counter-transfer and the voltage corresponding to the gradation of said display data is smaller than the difference between said voltage to prevent counter-transfer and the voltage corresponding to the original display data. Such a voltage is an example of the predetermined voltage of the present invention.

This embodiment has been explained assuming that the source driver 11 corrects gradation of the display colors during the 1 horizontal scanning periods T3, T4, T5 according to the temperature and gradation, but the present invention is not limited to this. It is also possible for the source driver 11 to correct gradation of the display color during the 1 horizontal scanning period T2 according to the temperature and gradation.

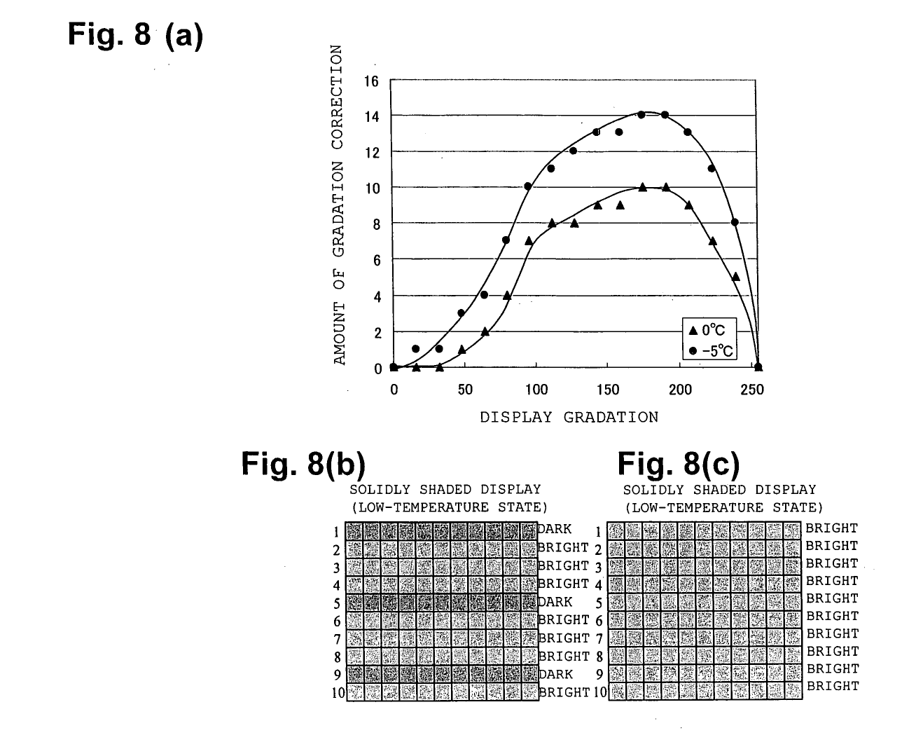

FIG. 8 shows such a gradation correction method.

In FIG. 8, when display gradation is, for example, 100, the source driver 11 corrects display gradation so that it is increased by 7 when the temperature is 0° C. Therefore, in this case, the source driver 11 supplies a voltage corresponding to 107 to the source signal line 13 as display gradation. Furthermore, even if the display gradation is 100, when the temperature is −5° C., the source driver 11 corrects display gradation so that it is increased by 10. Therefore, in this case, the source driver 11 supplies a voltage corresponding to 110 to the source signal line 13 as display gradation.

In this way, the source driver 11 corrects gradation of the display color during the 1 horizontal scanning period T2 according to the temperature and gradation. The amount of gradation correction is a positive value.

That is, when the temperature is as low as, for example, 10° C. or below, the voltage does not become one corresponding to the display color during the 1 horizontal scanning period T2, but even in such a case, the source driver 11 corrects gradation so that the gradation of the display color during the 1 horizontal scanning period T2 becomes greater, and can thereby prevent streaks which are more blackish than the original display color from appearing.

Therefore, as shown in FIG. 8(b), when gradation of the display color during the 1 horizontal scanning period T2 is not corrected, the pixel g1 to which the voltage corresponding to the display color is supplied during the 1 horizontal scanning period T2 is displayed in a blackish color. Therefore, streaks which are more blackish than the original display color appear on the display surface of the liquid crystal display panel 2. However, by carrying out gradation correction as described above, it is possible to prevent streaks which are more blackish than the original display color from appearing as shown in FIG. 8(c).

In FIG. 8, it has been explained that the source driver 11 corrects the gradation of the display color during the 1 horizontal scanning period T2 according to the temperature and gradation, but the present invention is not limited to this. When the insufficient charge of the source signal line 13 occurs during not only the 1 horizontal scanning period T2 but also T3, for example, the source driver 11 can correct gradation of the display color during the 1 horizontal scanning periods T2 and T3 according to the temperature and gradation. Thus, by correcting the gradation of the display color during the 1 horizontal scanning period when insufficient charge of the source signal line 13 occurs according to the temperature and gradation, the source driver 11 can achieve effects equivalent to those of this embodiment. In short, as the voltage corresponding to the gradation of said display data up to a predetermined number supplied to said source signal lines, any voltage will do as long as such a voltage is supplied that the difference between said voltage to prevent counter-transfer and the voltage corresponding to the gradation of the display data up to said predetermined number is greater than the difference between said voltage to prevent counter-transfer and the voltage corresponding to the original display data. Such a voltage is an example of the predetermined voltage of the present invention.

This embodiment has explained the case where the same halftone color is displayed on each pixel when a 1.25-fold speed conversion is performed as a counter-transfer prevention drive, but the present invention is not limited to this. Effects similar to those of this embodiment can be obtained even through a counter-transfer prevention drive whereby the voltage corresponding to the black color is applied to n pixels simultaneously to prevent counter-transfer and then voltages corresponding to display colors are sequentially applied to n pixels. When each pixel is displayed in not only a halftone color but also a white color, effects similar to those of this embodiment can be obtained.

This embodiment has been explained assuming that the black insertion voltage generation circuit 12 carries out a counter-transfer prevention drive, but the present invention is not limited to this. It is also possible not to provide the black insertion voltage generation circuit 12 and to allow the source driver 11 instead of the black insertion voltage generation circuit 12 to carry out a counter-transfer prevention drive. In that case, the source driver 11 will perform the function carried out by the black insertion voltage generation circuit 12 instead of the black insertion voltage generation circuit 12. The black insertion voltage generation circuit 12 may serve as the source driver 11, and the source driver 11 may serve as the black insertion voltage generation circuit 12.

### Fourth Embodiment

Next, a fourth embodiment will be explained.

The configuration of a liquid crystal display device using an OCB mode according to a fourth embodiment is shown in FIG. 1 as in the case of the first embodiment.

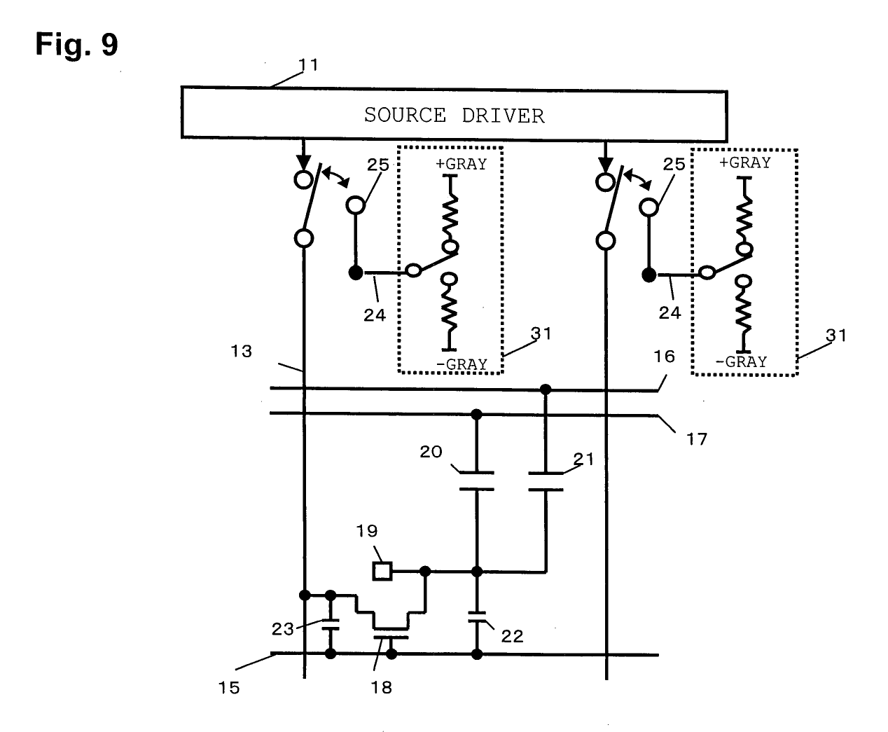

Furthermore, FIG. 9 shows the vicinity of 1 pixel, a source driver 11 and a black insertion voltage generation circuit 31 of a liquid crystal display panel 2 of the liquid crystal display device using the OCB mode.

In FIG. 9, the black insertion voltage generation circuit 31 is constructed so as to be able to supply a voltage which differs from one source signal line 13 to another. In FIG. 9, different black insertion voltage generation circuits 31 are provided for different source signals 13, but the present invention is not limited to this and the present invention can also be adapted so that one black insertion voltage generation circuit 31 can supply a plurality of voltages and each of the plurality of voltages is supplied to the corresponding source signal lines 13. Furthermore, the black insertion voltage generation circuit 12 according to the first embodiment in FIG. 2 supplies a voltage lower by a predetermined value than the voltage corresponding to the black color, but according to the fourth embodiment, the black insertion voltage generation circuit 31 supplies a voltage according to the voltage corresponding to the gradation to be displayed after the counter-transfer prevention drive as the voltage supplied to prevent a counter-transfer drive by the black insertion voltage generation circuit 31. The rest of the components in FIG. 9 are the same as those in the first embodiment.

Next, this embodiment will be explained centered on the difference from the first embodiment.

When the display operation is performed, the liquid crystal display device using the OCB mode in this embodiment as well as the liquid crystal display device explained in the conventional technology carries out a 1.25-fold speed conversion as a counter-transfer prevention drive. Furthermore, suppose that the temperature of the liquid crystal display panel 2 is as low as, for example, 10° C. or less. Furthermore, a case where the same halftone color is displayed on the liquid crystal display panel 2 will be explained.

That is, FIG. 15(a) shows each pixel in the direction of the source signal line 13. There is a queue of pixels g1, g2, . . . , g12, in the direction of the source signal line 13.

FIG. 15(b) illustrates timings when each pixel in FIG. 15(a) is displayed through a 1.25-fold speed conversion. In FIG. 15(b), periods each indicating a 1 horizontal scanning period are expressed by T1, T2, . . . T10 . . . FIGS. 15(a), (b) have already been explained in the conventional technology and explanations thereof will be omitted.

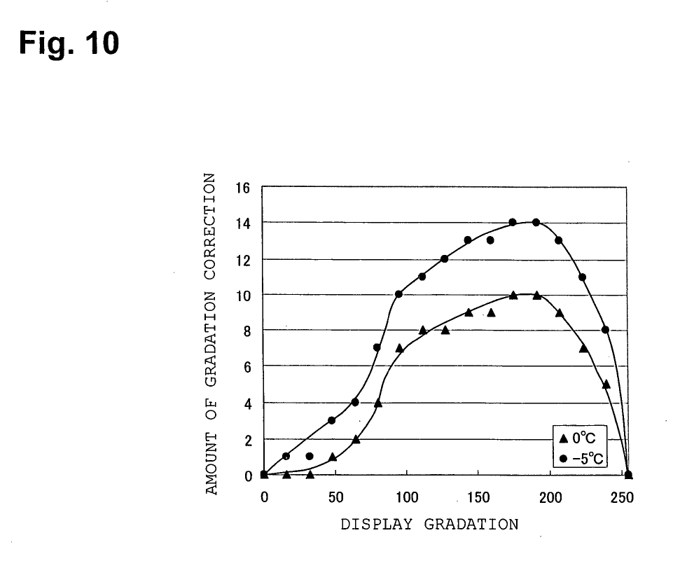

As the voltage to be supplied to each source signal line 13 as the voltage to prevent counter-transfer during a 1 horizontal scanning period T1, the black insertion voltage generation circuit 31 supplies a voltage according to the voltage corresponding to the halftone color to be displayed during T2 which is the 1 horizontal scanning period following the 1 horizontal scanning period T1. In order to determine the voltage to be supplied to each source signal line 13, the black insertion voltage generation circuit 31 calculates an amount of gradation correction from the black gradation first. FIG. 10 shows such a gradation correction method.

For example, when the display gradation to be displayed during T2 which is the 1 horizontal scanning period following the 1 horizontal scanning period T1 is 100, the black insertion voltage generation circuit 31 corrects the black gradation to be displayed during the 1 horizontal scanning period T1 so that it is increased by 7. Therefore, in this case, the black insertion voltage generation circuit 31 supplies the voltage corresponding to 7 as the display gradation to the source signal line 13 as the voltage to be supplied to prevent counter-transfer during the 1 horizontal scanning period T1. Furthermore, even if the display gradation during the 1 horizontal scanning period T2 is 100, if the temperature is −5° C., the black insertion voltage generation circuit 31 corrects the display gradation so that it is increased by 10. Therefore, in this case, the black insertion voltage generation circuit 31 supplies a voltage whose display gradation corresponds to 10 to the source signal line 13 as the voltage to be supplied to prevent counter-transfer during the 1 horizontal scanning period T1. The black insertion voltage generation circuit 31 determines the voltage to prevent counter-transfer for each source signal line 13 as described above and supplies the determined voltage to each source signal line 13.

In this way, the black insertion voltage generation circuit 31 determines the voltage to be supplied to prevent counter-transfer during the 1 horizontal scanning period T1 according to the temperature and also according to the display gradation during T2 which is the 1 horizontal scanning period immediately following the 1 horizontal scanning period T1.

That is, when the temperature is as low as, for example, 10° C. or below, the pixel g1 corresponding to the 1 horizontal scanning period T2 is not charged up to the voltage corresponding to the halftone color. However, even in such a case, by determining the voltage to be supplied during the 1 horizontal scanning period T1 by carrying out a gradation correction from the black gradation, it is possible to prevent streaks which are more blackish than the original display color from appearing.

This embodiment has explained the case where the same halftone color is displayed on each pixel when a 1.25-fold speed conversion is performed as a counter-transfer prevention drive, but the present invention is not limited to this. Effects similar to those of this embodiment can be obtained even through a counter-transfer prevention drive whereby the voltage corresponding to the black color is applied to n pixels simultaneously to prevent counter-transfer and then voltages corresponding to display colors are sequentially applied to n pixels. Furthermore, when each pixel is displayed in not only a halftone color but also a white color, effects similar to those of this embodiment can be obtained.

This embodiment has been explained assuming that the black insertion voltage generation circuit 31 carries out a counter-transfer prevention drive, but the present invention is not limited to this. It is also possible not to provide the black insertion voltage generation circuit 31 and to allow the source driver 11 instead of the black insertion voltage generation circuit 31 to carry out a counter-transfer prevention drive. In that case, the source driver 11 will perform the function carried out by the black insertion voltage generation circuit 31 instead of the black insertion voltage generation circuit 31. The black insertion voltage generation circuit 31 may serve as the source driver 11, and the source driver 11 may serve as the black insertion voltage generation circuit 31.

### Fifth Embodiment

Next, a fifth embodiment will be explained.

The configuration of a liquid crystal display device using an OCB mode according to a fifth embodiment is shown in FIG. 1 as in the case of the first embodiment.

Furthermore, FIG. 2 shows the vicinity of 1 pixel, a source driver 11 and a black insertion voltage generation circuit 12 of a liquid crystal display panel 2 of the liquid crystal display device using the OCB mode. However, though Embodiment 1 has explained that the black insertion voltage generation circuit 12 supplies a voltage lower by a predetermined value than the voltage corresponding to the black color, but the fifth embodiment assumes that the black insertion voltage generation circuit 12 supplies a voltage corresponding to the black color.

The difference between the liquid crystal display device using the OCB mode according to the fifth embodiment and the liquid crystal display device using the OCB mode according to the first embodiment is that the controller circuit 6 changes the length of a 1 horizontal scanning period.

Next, the operation of this embodiment will be explained centered on the difference from the first embodiment.

When the display operation is performed, the liquid crystal display device using the OCB mode in this embodiment as well as the liquid crystal display device explained in the conventional technology carries out a 1.25-fold speed conversion as a counter-transfer prevention drive. Furthermore, suppose that the temperature of the liquid crystal display panel 2 is as low as, for example, 10° C. or less. Furthermore, a case where the same halftone color is displayed on the liquid crystal display panel 2 will be explained.

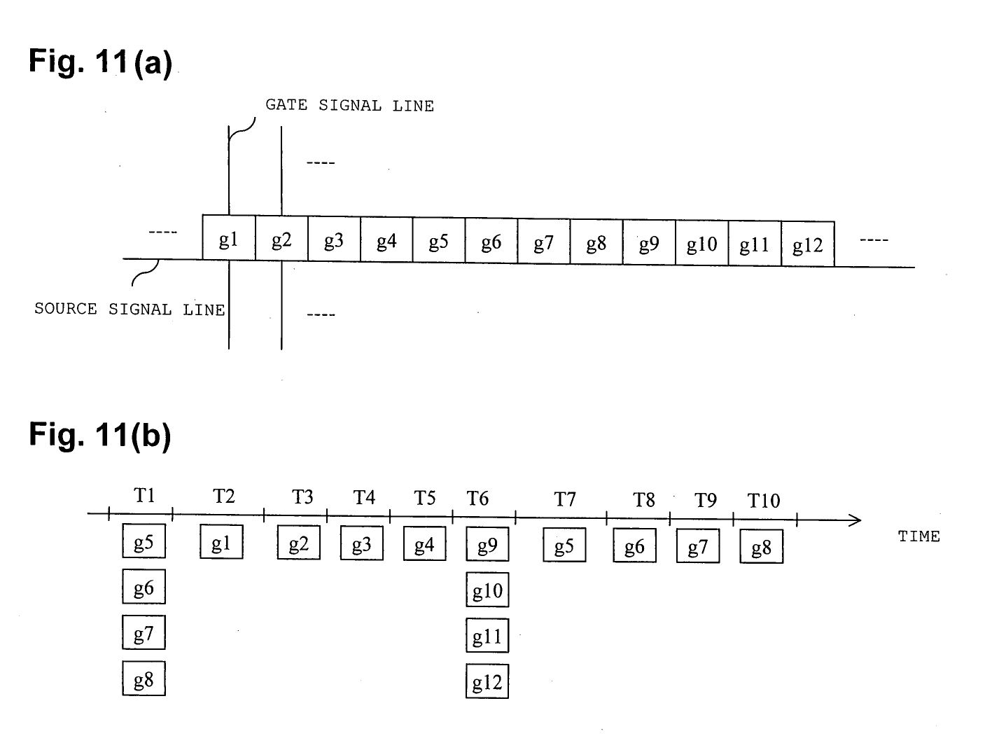

That is, FIG. 11(a) shows each pixel in the direction of the source signal line 13. There is a queue of pixels g1, g2, . . . , g12, . . . in the direction of the source signal line 13.

FIG. 11(b) illustrates timings when each pixel in FIG. 11(a) is displayed through a 1.25-fold speed conversion. In FIG. 11(b), periods each indicating a 1 horizontal scanning period are expressed by T1, T2, . . . T10 . . . . The difference between FIGS. 11(a), (b) and FIG. 15 explained in the conventional technology is that the 1 horizontal scanning periods T2, T7 are longer than other 1 horizontal scanning periods in FIG. 11(b). That is, the 1 horizontal scanning period following the 1 horizontal scanning period during which a counter-transfer prevention drive is performed is longer than the subsequent 1 horizontal scanning periods.

However, the total length of T1, T2, T3, T4 and T5 remains unchanged. For example, if T2 is multiplied 1.4 times, the lengths of T1, T3, T4 and T5 can be 0.9 times their original lengths.

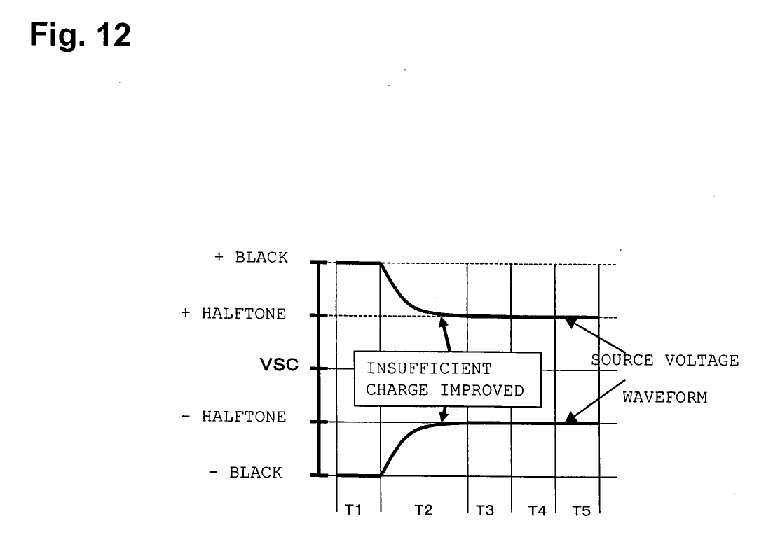

FIG. 12 shows a voltage waveform of the source signal line 13 of the liquid crystal display device using the OCB mode of this embodiment. The voltage waveform of the source signal line 13 in FIG. 12 is a voltage waveform when the same halftone color is displayed on each pixel. Furthermore, the horizontal axis of the voltage waveform of the source signal line 13 in FIG. 12 shows the 1 horizontal scanning periods T1, T2, T3, T4 and T5 shown in FIG. 11(b).

As is observed from the source voltage waveform in FIG. 12, the voltage of the source signal line 13 during the 1 horizontal scanning period T1, that is, a period during which a drive for preventing counter-transfer is performed is set to a voltage corresponding to the black color. Then, the voltage of the source signal line 13 during the 1 horizontal scanning period T2, that is, a period during which a halftone color is displayed is set to a voltage corresponding to the halftone color.

Likewise, all voltages of the source signal line 13 during 1 horizontal scanning periods T3, T4, T5, that is, a period during which a halftone color is displayed are set to a voltage corresponding to the halftone color.

The 1 horizontal scanning period T2 is set to be longer than the 1 horizontal scanning period T1, T3, T4, T5.

Thus, this embodiment provides the 1 horizontal scanning period T2 longer than the horizontal scanning periods T1, T3, T4, T5, and can thereby set the voltage of the source signal line 13 to the voltage corresponding to the halftone color displayed when the voltage corresponding to the halftone color is written immediately after a counter-transfer prevention drive.

Thus, according to this embodiment, the 1 horizontal scanning period when the voltage corresponding to the halftone color immediately after the voltage corresponding to the black color is applied is set to be longer than the second and subsequent 1 horizontal scanning periods, and it is thereby possible to solve the problem of insufficient charge of the source signal line 13 and set the source signal line 13 to the voltage corresponding to the halftone color. Therefore, it is possible to prevent streaks which are more blackish than the original display color from appearing on the liquid crystal display panel 2.

This embodiment has been explained assuming that the controller circuit 6 makes the 1 horizontal scanning period T2 longer than the 1 horizontal scanning periods T3, T4, T5, but the present invention is not limited to this. When insufficient charge of the source signal line 13 occurs during not only the 1 horizontal scanning period T2 but also, for example, T3, the controller circuit 6 can make the 1 horizontal scanning periods T2 and T3 longer than the 1 horizontal scanning periods T4, T5. Thus, by making the 1 horizontal scanning period during which insufficient charge of the source signal line 13 occurs longer than the 1 horizontal scanning period during which no insufficient charge of the source signal line 13 occurs, the controller circuit 6 can obtain effects equivalent to those of this embodiment.

In short, that wherein said display period corresponding to said display data up to a predetermined number supplied to said source signal lines is longer than said display period corresponding to said display data after said predetermined number is an example of predetermined voltage of the present invention.

This embodiment has explained that the black insertion voltage generation circuit 12 performs a counter-transfer prevention drive, but the present invention is not limited to this. It is also possible not to provide the black insertion voltage generation circuit 12 and to allow the source driver 11 instead of the black insertion voltage generation circuit 12 to carry out a counter-transfer prevention drive. In such a case, the source driver 11 will carry out the function carried out by the black insertion voltage generation circuit 12 instead of the black insertion voltage generation circuit 12.

The black insertion voltage generation circuit 12 may serve as the source driver 11, and the source driver 11 may serve as the black insertion voltage generation circuit 12. The liquid crystal display device and method of driving the liquid crystal display device according to the present invention has the effect of preventing streaks which are more blackish than the original display color from appearing on the display surface of the display panel even when the temperature is low or when each pixel is displayed in the same halftone color or white color and is effectively applicable to a liquid crystal display device using OCB mode liquid crystal and a method of driving the liquid crystal display device, etc.

What is claimed is:

1. A liquid crystal display device comprising:
a liquid crystal display panel having source signal lines and gate signal lines arranged in matrix form and liquid crystal display elements using OCB mode liquid crystal, said liquid crystal display elements being provided at intersections between said source signal lines and gate signal lines;
a gate driver that supplies a gate signal to said gate signal lines;
a source driver that supplies a voltage corresponding to gradation of display data to said source signal lines during a display period; and
a black insertion voltage generation circuit that supplies a voltage to prevent counter-transfer to said source signal lines during a counter-transfer prevention drive period,
wherein a voltage of source signal lines is supplied with a voltage adjusted to a voltage value corresponding to predetermined voltage value (1) during a period after said black insertion voltage generation circuit supplies said voltage to prevent counter-transfer in said counter-transfer prevention drive period or (2) during a period before the voltage corresponding to the gradation of display data is supplied to said source signal lines in said display period.

2. The liquid crystal display device according to claim 1, wherein said voltage adjusted to a voltage value corresponding to predetermined voltage value means such a voltage that a voltage of said source signal lines becomes a voltage corresponding to a halftone color.

3. The liquid crystal display device according to claim 2, wherein said black insertion voltage generation circuit supplies, as the voltage to be supplied to prevent counter-transfer during said counter-transfer prevention drive period, a voltage according to the voltage corresponding to the gradation of said display data supplied to said source signal lines after the counter-transfer prevention drive period.

4. The liquid crystal display device according to claim 2, wherein said black insertion voltage generation circuit supplies, as the voltage supplied to prevent counter-transfer during said counter-transfer prevention drive period, a voltage according to a temperature.

5. The liquid crystal display device according to claim 2, wherein said black insertion voltage generation circuit may serves as said source driver.

6. The liquid crystal display device according to claim 5, wherein in case said black insertion voltage generation circuit serves as said source driver, said source driver supplies, as the voltage supplied to prevent counter-transfer during said counter-transfer prevention dive period, a voltage according to the voltage corresponding to gradation of said display data supplied to said source signal lines after the counter-transfer prevention drive period.

7. The liquid crystal display device according to claim 5, wherein in case said black insertion voltage generation circuit serves as said source driver, said source driver supplies, as the voltage supplied to prevent counter-transfer during said counter-transfer prevention drive period, a voltage according to a temperature.

8. The liquid crystal display device according to claim 5, wherein in case said black insertion voltage generation circuit serves as said source driver, said source driver supplies such a voltage that a voltage of said source signal lines becomes the voltage corresponding to a halftone color to said source signal lines during a period after said source driver supplies said voltage to prevent counter-transfer in said counter-transfer prevention drive period.

9. The liquid crystal display device according to claim 5, wherein in case said black insertion voltage generation circuit serves as said source driver, said source driver supplies such a voltage that a voltage of said source signal lines becomes the voltage corresponding to a halftone color to said source signal lines during a period after said source driver supplies said voltage to prevent counter-transfer in said counter-transfer prevention drive period.

10. The liquid crystal display device according to claim 1, wherein in case a voltage of source signal lines is supplied with a voltage adjusted to a voltage value corresponding to predetermined voltage value during a period after said black insertion voltage generation circuit supplies said voltage to prevent counter-transfer in said counter-transfer prevention drive period,
that wherein said voltage of source signal lines is supplied with a voltage adjusted to a voltage value corresponding to predetermined voltage value means that, as the voltage corresponding to the gradation of said display data up to a predetermined number supplied to said source signal lines after said counter-transfer prevention drive period, such a voltage is supplied that the difference between said voltage to prevent counter-transfer and the voltage corresponding to the gradation of the display data up to said predetermined number is greater than the difference between said voltage to prevent counter-transfer and the voltage corresponding to the original display data.

11. The liquid crystal display device according to claim 10, wherein said black insertion voltage generation circuit may serves as said source driver.

12. The liquid crystal display device according to claim 1, wherein in case a voltage of source signal lines is supplied with a voltage adjusted to a voltage value corresponding to predetermined voltage value during a period after said black insertion voltage generation circuit supplies said voltage to prevent counter-transfer in said counter-transfer prevention drive period,
that wherein said voltage of source signal lines is supplied with a voltage adjusted to a voltage value corresponding to predetermined voltage value means that, as the voltage corresponding to the gradation of all said display data after a predetermined number supplied to said source signal lines after said counter-transfer prevention drive period, such a voltage is supplied that the difference between said voltage to prevent counter-transfer and the voltage corresponding to the gradation of said display data is smaller than the difference between said voltage to prevent counter-transfer and the voltage corresponding to the original display data.

13. The liquid crystal display device according to claim 12, wherein said black insertion voltage generation circuit may serves as said source driver.

14. The liquid crystal display device according to claim 1, wherein in case a voltage of source signal lines is supplied with a voltage adjusted to a voltage value corresponding to predetermined voltage value during a period after said black insertion voltage generation circuit supplies said voltage to prevent counter-transfer in said counter-transfer prevention drive period,
that wherein said voltage of source signal lines is supplied with a voltage adjusted to a voltage value corresponding to predetermined voltage value means that said display period corresponding to said display data up to a predetermined number supplied to said source signal lines after said counter-transfer prevention drive period is longer than said display period corresponding to said display data after said predetermined number.

15. The liquid crystal display device according to claim 14, wherein said black insertion voltage generation circuit may serves as said source driver.

16. A method of driving a liquid crystal display device, said liquid crystal display device comprising:
a liquid crystal display panel having source signal lines and gate signal lines arranged in matrix form and liquid crystal display elements using OCB mode liquid crystal, said liquid crystal display elements being provided at intersections between said source signal lines and gate signal lines;
a gate driver that supplies a gate signal to said gate signal lines;
a source driver that supplies a voltage corresponding to gradation of display data to said source signal lines during a display period; and
a black insertion voltage generation circuit that supplies a voltage to prevent counter-transfer to said source signal lines during a counter-transfer prevention drive period, said method comprising a step of supplying a voltage of source signal lines with a voltage adjusted to a voltage value corresponding to predetermined voltage value (1) during a period after said black insertion voltage generation circuit supplies said voltage to prevent counter-transfer in said counter-transfer prevention drive period or (2) during a period before the voltage corresponding to the gradation of display data is supplied to said source signal lines in said display period.

17. The method of driving a liquid crystal display device, according to claim 16, wherein said voltage adjusted to a voltage value corresponding to predetermined voltage value means such a voltage that said source signal lines becomes a voltage corresponding to a halftone color.

18. The method of driving a liquid crystal display device, according to claim 17, wherein said black insertion voltage generation circuit may serves as said source driver.

19. The method of driving a liquid crystal display device, according to claim 16, wherein in case a voltage of source signal lines is supplied with a voltage adjusted to a voltage value corresponding to predetermined voltage value during a period after said black insertion voltage generation circuit supplies said voltage to prevent counter-transfer in said counter-transfer prevention drive period,
that wherein said voltage of source signal lines is supplied with a voltage adjusted to a voltage value corresponding to predetermined voltage value means that, as the voltage corresponding to the gradation of said display data up to a predetermined number supplied to said source signal lines after said counter-transfer prevention drive period, such a voltage is supplied that the difference between said voltage to prevent counter-transfer and the voltage corresponding to the gradation of the display data up to said predetermined number is greater than the difference between said voltage to prevent counter-transfer and the voltage corresponding to the original display data.

20. The method of driving a liquid crystal display device, according to claim 19, wherein said black insertion voltage generation circuit may serves as said source driver.

21. The method of driving a liquid crystal display device, according to claim 16, wherein in case a voltage of source signal lines is supplied with a voltage adjusted to a voltage value corresponding to predetermined voltage value during a period after said black insertion voltage generation circuit supplies said voltage to prevent counter-transfer in said counter-transfer prevention drive period,
that wherein said voltage of source signal lines is supplied with a voltage adjusted to a voltage value corresponding to predetermined voltage value means that, as the voltage corresponding to the gradation of all said display data after a predetermined number supplied to said source signal lines after said counter-transfer prevention drive period, such a voltage is supplied that the difference between said voltage to prevent counter-transfer and the voltage corresponding to the gradation of said display data is smaller than the difference between said voltage to prevent counter-transfer and the voltage corresponding to the original display data.

22. The method of driving a liquid crystal display device, according to claim 21, wherein said black insertion voltage generation circuit may serves as said source driver.

23. The method of driving a liquid crystal display device, according to claim 16, wherein in case a voltage of source signal lines is supplied with a voltage adjusted to a voltage value corresponding to predetermined voltage value during a period after said black insertion voltage generation circuit supplies said voltage to prevent counter-transfer in said counter-transfer prevention drive period,
that wherein said voltage of source signal lines is supplied with a voltage adjusted to a voltage value corresponding to predetermined voltage value means that said display period corresponding to said display data up to a predetermined number supplied to said source signal lines after said counter-transfer prevention drive period is longer than said display period corresponding to said display data after said predetermined number.

24. The method of driving a liquid crystal display device, according to claim 23, wherein said black insertion voltage generation circuit may serves as said source driver.
